(19) United States
(12) Patent Application Publication
(10) Pub. No.: US 2017/0140093 A1
(43) Pub. Date: May 18, 2017

(54) METHODS AND SYSTEMS FOR IN SILICO DESIGN

(71) Applicant: LIFE TECHNOLOGIES HOLDINGS PTE LIMITED, Carlsbad, CA (US)

(72) Inventors: Kevin CLANCY, Carlsbad, CA (US); Kin Chong Sam, Singapore (SG); Kok Hien Gan, Johor Bahru (MY); Haw Siang Brandon Ang, Singapore (SG); Kaleeswari Palaniappan, Singapore (SG)

(21) Appl. No.: 15/358,014

(22) Filed: Nov. 21, 2016

Related U.S. Application Data
(62) Division of application No. 14/106,680, filed on Dec. 13, 2013.
(60) Provisional application No. 61/737,511, filed on Dec. 14, 2012.

(51) Int. Cl. G06F 19/12; G06F 19/16

(52) U.S. Cl. CPC G06F 19/12; G06F 19/16

(57) ABSTRACT

Embodiments describe computer systems and computer programs for implementing BioCAD methods comprising one or more data models and one or more BioCAD tools, wherein the BioCAD tools enable users to design or refactor a biomolecule or to conduct a biological experiment in silico by user input of one or more components selected by the user from a database populated with information on components and scientific data of existing biomolecules and experiments. Data models of the programs are operable to manage development of the new biomolecule or experiment based on information in the databases. Computer programs also provide an output with information that enables the users to determine in silico if the newly designed or refactored molecule or biological experiment is satisfactory or not for its intended purpose in vitro and also provides the user the capability to re-design the biomolecule or experiment till it is satisfactory.

### CROSS-REFERENCE TO RELATED APPLICATIONS

This application is a divisional of U.S. Ser. No. 14/106,680 filed Dec. 13, 2013 which claims the benefit of U.S. Application No. 61/737,511 filed Dec. 14, 2012, the disclosures of which are herein incorporated by reference in their entirety.

### FIELD OF THE DISCLOSURE

The present disclosure relates to synthetic biology and especially to biological computer aided design tools and computer programs comprising computer systems, computer software and computer tools. Various embodiments describe one or more computer implemented methods including but not limited to, methods for in silico design (e.g., of biomolecules, of biological experiments, of biological workflows), methods of collection and management of biological data, methods of data analysis, and/or to methods for ordering materials and methods of executing in vitro experiments based on in silico designs and/or in silico methods.

### BACKGROUND

Biotechnology research is important for improving agricultural products, discovering new treatments for diseases, for identifying and developing new diagnostic methods etc. and relies on complex technologies, methods and experimental design. This research would be greatly facilitated by better computer assisted experimental design programs.

Existing computer programs are limited to stitching together existing biomolecule parts to form a designed biomolecule. However, they are unable to provide a user any indication of whether such a designed molecule can or will function in a biological environment, for example in a cell. Existing software also cannot provide a user any indication of potential problems associated with the design of a biomolecule. Furthermore, current software assisted design methods are unable to anticipate how a designed molecule may interact with other molecules in an in vivo or in vitro environment and hence, a user has to perform time and resource consuming in vitro experiments before he/she can know if a designed molecule will work for the intended end purpose.

### SUMMARY OF THE DISCLOSURE

The present disclosure, in some embodiments, comprises a computer program for biological computer aided design (BioCAD) to provide integrated bioinformatics solutions for many bioinformatics methods including non limiting examples such as in silico designing of biomolecules; and/or or in silico designing of biological experiments and/or in silico designing of biological workflows; and/or in silico refactoring of existing designs/designed biomolecules/biomolecules; and/or analysis of various biomolecules and/or analysis of various biological experiments, wherein the computer program has the ability to provide feedback to a user about the in silico result obtained and allow the user to go back and change the bioinformatics method to make it optimal. In some embodiments, feedback provided by a computer program of the disclosure includes not only data on the in silico design but also feedback about how the in silico designed experiment or biomolecule would function in vitro and in vivo and feedback about potential problems with the designed experiment, workflow or biomolecule that would not allow it to function optimally or function at all in an in vitro or in vivo environment. In some embodiments, a computer program of the disclosure comprises one or more data models and one or more BioCAD tools, the computer program comprising a non-transitory computer-readable storage medium encoded with instructions for implementing the one or more BioCAD tools and instructions for accessing or obtaining data from the one or more data models, executable by a processor, and comprising instructions for carrying out various steps of the one or more bioinformatics method.

In one embodiment, the disclosure comprises a computer program for implementing a biological computer aided design (BioCAD) comprising a non-transitory computer-readable storage medium encoded with instructions, executable by a processor, comprising: at least one data model; and at least one BioCAD tool; wherein the at least one BioCAD tool enables a user to design a new designed biomolecule or to refactor an existing or previously designed biomolecule based on the user's input of one or more components of a Part, a Device and/or a Circuit selected by the user from a database that comprises a plurality of components of existing biomolecules; wherein the at least one data model is operable to manage development of the new designed or refactored biomolecule using one or more databases populated with information on the components of existing biomolecules; and the computer program comprising instructions to perform an analysis of information on the components of the new designed biomolecule or refactored biomolecule; and the computer program comprising instructions to provide the user an output comprising information that enables the user to determine in silico if the new designed biomolecule or refactored molecule is satisfactory or if one or more problems are associated with the new designed or refactored biomolecule. The one or more components, also referred to herein as parameters, can comprise parts, devices, circuits, host cells, small molecules, composite-parts/devices/circuits/host-cells/small-molecules, temperature, pH, buffers, and a variety of components that may be needed for designing or refactoring a biomolecule or biological experiment.

In some embodiments of a computer program of the disclosure, the output, as described above, further comprises information identifying the source of the one or more problem to in silico selection by the user of one or more components of the Parts, the Devices or the Circuits used to design or refactor the biomolecule. A computer program of the disclosure can further comprise instructions to provide the user the ability to resolve the one or more problems by reselecting a different Part, Device and/or Circuit. In some embodiments, the one or more problems identified by a computer program of the disclosure can comprise non-limiting examples such as: a) determining if the new designed or refactored biomolecule is compatible with an in vivo environment that it has been designed for; b) identifying potential errors in silico prior to development work in vivo or in vitro; c) determining if the new designed or refactored biomoleculs can interact with other molecules as desired; d) determine if the new designed or refactored biomolecule cannot interact with other molecules as desired; and e) determining if the new designed or refactored biomolecule has undesired interactions with other molecules, wherein the other molecules are biomolecules, proteins, peptides, antibodies, nucleic acids or small molecules.

In some embodiments, a computer program of the disclosure can have instructions to enable a Part to be identified as a Part with an identified functional role and an associated biological, experimental and usage metadata and instructions to include the representation of Parts and Part metadata in the data model; instructions to enable a Device to be identified as a Device with an identified functional role and an associated biological, experimental and usage metadata and instructions to include the representation of Device and Device metadata in the data model; and instructions to enable a Circuit to be identified as a Circuit with an identified functional role and an associated biological, experimental and usage metadata and instructions to include the representation of Circuits and Circuit metadata in the data model.

In addition a computer program of the disclosure can further have: instructions to enable the definition and use of one or more Small Molecules with identified functional role and associated biological, experimental and usage metadata and instructions to include the representation of Small Molecules and Small Molecule metadata in the data model; and instructions to enable the definition and use of interactions between native biomolecules, Small Molecules, Parts, Devices and Circuits with identified functional role and associated biological, experimental and usage metadata and instructions to include the representation of interactions and interaction metadata in the data model.

In some embodiments, a computer program of the disclosure can further have instructions to enable the identification of a Host with associated biological properties and associated biological, experimental and usage metadata and instructions to include the representation of the Host and Host metadata in the data model.

In some embodiments, a computer program of the disclosure can further have instructions to enable the identification of an Assay with associated experimental properties and results and associated biological, experimental and usage metadata and instructions to include the representation of the Assay and Assay metadata in the data model. Assay metadata can include the experimental results derived from measurement of one or more of Parts, Devices, Circuits, Hosts and Small Molecules in the Assay.

In some embodiments, a computer program of the disclosure can further comprise instructions to enable the development, use and management of collections of Small Molecules, Parts, Devices, Circuits, Hosts and Experimental Assay data.

In some embodiments, in a computer program of the disclosure at least one BioCAD tool comprised therein enables a user to design a biological experiment and to design a biological workflow relating to the designed biomolecule or refactored biomolecule.

In some embodiments the disclosure describes a computer program comprising a plurality of data models and BioCAD tools. In one exemplary embodiment a computer program comprising a plurality of data models and BioCAD tools comprises: a) a data model to manage the development of the new designed or refactored biomolecule the data model based on synthetic biology engineering data; b) a tool to enable the design of Parts, Devices and Circuits from existing biomolecules; c) a tool to enable the refactoring of Parts, Devices and circuits from existing biomolecules or previously designed constructs; d) a tool to scan, design and refactor transcriptional and translational properties of designed or refactored biomolecule; e) a tools to scan, design and refactor cloning methods that are compatible with a host system chosen for cloning; f) a tool to identify and resolve potential errors in silico prior to performing development work in vivo or in vitro; g) a tools and a data model to manage and incorporate experimental data as part of design and refactoring of a biomolecule; and h) a tool and a data model to manage projects containing both the new designed or refactored biomolecule with their corresponding native biomolecules or systems.

Computer programs of the disclosure can use a plurality of icons to graphically depict Parts, Devices, Circuits, Small Molecules, Hosts and the interactions between parts, Devices, Circuits, and Small Molecules.

In one embodiment, a computer program comprising one or more data models and one or more BioCAD tools, comprises a non-transitory computer-readable storage medium encoded with instructions the instructions comprising: a) instructions for one or more in silico methods including, but not limited to, methods for: 1. designing a biomolecule; 2. redesigning or refactoring an existing biomolecule; 3. designing a biological experiment; and 4. designing a biological workflow, wherein each of the in silico methods comprise a plurality of steps; b) instructions for providing access to a user to one or more biological database to access and obtain information therefrom, wherein the biological database is situated locally on a desktop, on a server, or in a cloud; c) instructions for collecting biological data from the one or more biological database; d) instructions for analyzing the collected biological data; e) instructions to interact with the one or more data models; f) instructions to enable the one or more BioCAD tools; g) instructions for providing a user ability to navigate to any step of an in silico method as described above; h) instructions for providing a user the ability to view, set, or change one or more parameters associated with each step; i) instructions for providing a user the ability to view the designed or refactored biomolecule or an intermediate of a designed or refactored biomolecule or the results or intermediate results of the designed biological experiment or the designed biological workflow to decide if the designed biomolecule or the designed experiment or the designed workflow is satisfactory; k) instructions for allowing a user to share the designed or refactored biomolecule or intermediates results with other users and obtain input from the other users; and l) instructions for providing the user iterative design capability comprising ability at any step to go back to any previous steps to modify parameters if the design is not satisfactory.

Additional instructions encoded in a non-transitory computer-readable storage medium, executable by a processor, for implementing a BioCAD tool of this disclosure may include but are not limited to: instructions comprising specification requirements of a biomolecule, a biological experiment and/or a biological workflow; instructions comprising constraints of design, including for example constraints of designing a biomolecule, constraints of a biological experiment and/or workflow; instructions for methods for management of biological data; instructions for methods for collection of biological parts and for development of compositions of designs and design solutions from the parts collections and/or experimental designs using the parts collections and/or reagent development activities using parts collections; instructions that permit users to Curate collections of data; instructions that permits users to discover new information about their own data; instructions that permit users to design tools, reagents and clones based upon biological data; instructions that permit users to simulate and confirm lab based experimental findings against in silico designs, discover and order reagents from commercial vendors and manage reagent collections with in silico designs; instructions that permit users customize their interaction with the software and to share this with other users; instructions that permits users the ability to design and develop synthetic biology parts, devices and circuits from native or wild type biological sequences; instructions that permit users refactor, modify and redevelop synthetic biology parts, devices and circuits from native or wild type biological sequences; instructions that permits users develop Parts from native or wild type biological sequences; instructions that permits users to characterize Parts with associated data, such as use of Ontology terms; instructions that permits users characterize Parts with associated experimental data; instructions which allows a user to utilize data sheets to summarize information about a Part, Device or Circuit; instructions that permits user to organize Parts into collections; instructions to enable users to design develop and manage information on collections of Devices; instructions to enable users to design develop and manage information on collections of Circuits; instructions to enable users to develop circuits based upon defined interactions with external define elements. One or more steps that comprise these instructions are described in additional detail later in the specification.

In some embodiments, a non-transitory computer-readable storage medium encoded with instructions, executable by a processor, for implementing a one or more BioCAD tools and obtaining or accessing data from one or more data models, comprises a plug-in architecture for database, tools and viewers. In some embodiments, a non-transitory computer-readable storage medium encoded with instructions, executable by a processor, for implementing a BioCAD tool comprises a reusable architecture enabling development of solutions for local systems and systems accessible over a network, including desktop, server and cloud-based solutions and/or a defined application programming interface to enable easy access to and reuse of the code base for new application development.

In some embodiments, a BioCAD program comprising a non-transitory computer-readable storage medium encoded with instructions, executable by a processor as described herein can further comprise: executing a first method for designing a biomolecule and/or a biological experiment or a biological workflow to obtain a product, comprising selecting a first set of parameters for each step and executing in silico all the steps of the in silico method; viewing in silico a first biomolecule or a first product obtained by executing the first in silico method; generation of at least a second method for designing the biomolecule and/or a biological experiment or a biological workflow to obtain the product, comprising selecting a second set of parameters for each step where the second set of parameters each have a different value relative to the same parameter selected in the first method and executing all the steps of the second method in silico; viewing the second biomolecule or second product in silico; and comparing the first biomolecule or first product with the second biomolecule or second product; repeating this for as many “n” iterations as needed; allowing a user to compare the first, second, third . . . nth product or biomolecule to each other and thereby allowing a user to determine which among the first, second, third . . . nth set of parameters and produces a preferred biomolecule or preferred product.

In some embodiments, the disclosure describes a computer-implemented method for designing a new biomolecule or to refactor an existing or previously designed biomolecule or to design a new experiment or a workflow comprising: using a computer program for implementing a biological computer aided design (BioCAD) comprising a non-transitory computer-readable storage medium encoded with instructions, executable by a processor, comprising: at least one data model; and at least one BioCAD tool; wherein the at least one BioCAD tool enables a user to design a new designed biomolecule or to refactor an existing or previously designed biomolecule based on the user's input of one or more components of a Part, a Device and/or a Circuit selected by the user from a database that comprises a plurality of components of existing biomolecules; wherein the at least one data model is operable to manage development of the new designed or refactored biomolecule using one or more databases populated with information on the components of existing biomolecules; and the computer program comprising instructions to perform an analysis of information on the components of the new designed biomolecule or refactored biomolecule; and the computer program comprising instructions to provide the user an output comprising information that enables the user to determine in silico if the new designed biomolecule or refactored molecule is satisfactory or if one or more problems are associated with the new designed or refactored biomolecule.

In some embodiments, the disclosure further comprises development of an optimal in silico method for designing or refactoring a biomolecule comprising: implementing the BioCAD computer program to perform in silico a series of preliminary method steps for designing or refactoring a biomolecule by allowing a user to select a preliminary set of one or more parameters including one or more of the following: parts, devices, circuits that constitute the designed or refactored biomolecule; implementing the BioCAD computer program to analyze the designed or refactored biomolecule comprising using the at least BioCAD tool and at least one data model and associated metadata for the analysis; obtaining output generated by the computer program to identify any problem with the designed or refactored biomolecule; implementing the data model to identify one or more steps of the preliminary method that caused the problems with the designed or refactored biomolecule; using the computer program to refine individual steps identified to be the source of the problems of the preliminary method by allowing the user to reselect a secondary set of one or more parameters including one or more of the following: parts, devices, circuits that constitute the designed or refactored biomolecule; and repeating this process of refining individual steps and reviewing the results in silico until an optimal designed or refactored molecule is obtained.

The disclosure also comprises computer-implemented methods comprising: an in silico method for development of an optimal method for designing a biomolecule or an optimal method for performing an biological experimental method or a biological workflow, the in silico method comprising: using/implementing a BioCAD tool to perform in silico a series of preliminary method steps for designing a biomolecule or a series of preliminary biological experimental method or a series of preliminary biological workflow steps; refining individual steps of the preliminary method by: varying in silico used based input selections of one or more parameters of one or more of the preliminary method steps; and optionally varying one or more of the preliminary method steps; reviewing in silico the results of the preliminary method comprising reviewing either a preliminary designed biomolecule or a result of the preliminary experimental method or the preliminary workflow method; and repeating this process of refining individual steps and reviewing the results in silico until an optimal designed molecule or experimental method is arrived at. In some embodiments, this is followed by performing the optimally designed method/experiment/workflow in a laboratory or commercially in a factory to produce a biomolecule or a biological product/products.

In a computer implemented method of the disclosure parameters can comprise any component/reagent/conditions that is needed for a method step and includes user based selection of one or more of the following: parts, devices, circuits, temperature, pH, buffers, reagents and other conditions that are needed for a method step. In a computer implemented method of the disclosure varying one or more of the preliminary method steps can comprise one or more including: varying the sequence of steps, or varying the components of steps, adding new steps, removing older (preliminary method) steps, modifying older (preliminary method) steps.

The disclosure also comprises a computer system for BioCAD comprising: a processor; and a memory for storing instructions executable by the processor comprising instructions for implementing one or more BioCAD tools of the disclosure and instructions for accessing or obtaining data from a data model such that the data model can manage the BioCAD, wherein the instructions comprise a computer program and the BioCAD is related to designing a biomolecule, and/or to refactoring an existing or previously designed biomolecule, and/or the BioCAD comprises steps of an in silico biology method.

Some embodiments of the disclosure describe a system comprising: a) a processor; and b) a memory for storing instructions executable by the processor comprising the computer program comprising: a computer program for implementing a biological computer aided design (BioCAD) comprising a non-transitory computer-readable storage medium encoded with instructions, executable by a processor, comprising: at least one data model; and at least one BioCAD tool; wherein the at least one BioCAD tool enables a user to design a new designed biomolecule or to refactor an existing or previously designed biomolecule based on the user's input of one or more components of a Part, a Device and/or a Circuit selected by the user from a database that comprises a plurality of components of existing biomolecules; wherein the at least one data model is operable to manage development of the new designed or refactored biomolecule using one or more databases populated with information on the components of existing biomolecules; and the computer program comprising instructions to perform an analysis of information on the components of the new designed biomolecule or refactored biomolecule; and the computer program comprising instructions to provide the user an output comprising information that enables the user to determine in silico if the new designed biomolecule or refactored molecule is satisfactory or if one or more problems are associated with the new designed or refactored biomolecule.

The disclosure also comprises a system for BioCAD comprising: a processor; and a memory for storing instructions executable by the processor comprising instructions for implementing one or more BioCAD tools of the disclosure and instructions for accessing or obtaining data from a data model such that the data model can manage the BioCAD, wherein the instructions comprise a computer program, and the BioCAD is for one or more of the following:

providing an in silico method for designing a biomolecule;

redesigning or refactoring an existing or previously designed biomolecule;

providing an in silico method for designing a biological experiment;

providing an in silico method for designing a biological workflow;

providing access to a user to one or more biological databases to access and obtain information therefrom, wherein the biological database is situated on a desktop, a server or in a cloud;

providing an in silico method to collect biological data;

providing an in silico method to analyze the collected biological data,

providing a user ability to navigate to any step of an in silico method as described above;

providing a user the ability to view, set, or change one or more parameters associated with each step of an in silico method as described above; and

providing a user the ability to view the designed biomolecule or an intermediate designed biomolecule or the results or intermediate results of the designed biological experiment or the designed biological workflow to decide if the designed biomolecule or the designed experiment or the designed workflow is satisfactory; and

providing the user ability at any step of an in silico method as described above to go back to any previous steps to modify parameters if the design is not satisfactory (i.e., providing a user iterative design capability).

One or more non-limiting advantageous of the methods, computer software and tools of disclosure is providing a user the ability to identify, trouble shoot and resolve problems during design of a biological molecule, and/or refactoring a biomolecule, and/or design of a biological method. In some embodiments, this comprises populating a data model with metadata having information about a part, device or circuit, of a designed/refactored biomolecule and accessing information or data stored in the data model on such parts and their properties and analyzing in silico the properties of the designed/refactored molecule. In some embodiments, identifying, trouble shooting and resolving a problem may, further to using a data model, and/or in the alternative, comprise initially performing/simulating user designed biological molecules or methods in silico, and allowing another user or a group of users to share and review the results of the designed biomolecule or method to obtain additional input on the design parameters (such as but not limitted to parts, devices, circuits, hosts, small molecules etc.). In addition, a method may comprise analysis of factors such as time, yield, efficiency of an experimental design/method and develop in silico better ways to arrive at the biological method or biomolecule. In some embodiments, collective user experiences and knowledge, as well as data obtained from in silico implementation of a preliminarily designed method can be used to improve upon and resolve issues in the method. This can save resources and time when the real wet lab or commercial scale biological method is performed.

### BRIEF DESCRIPTION OF THE FIGURES

FIG. 1 illustrates a general computer system architecture schematic according to an embodiment of the disclosure.

FIG. 2 is a block diagram that illustrates a computer system 700 that may be employed to carry out processing functionality, according to some exemplary embodiments of the disclosure.

FIG. 3 is a block diagram that illustrates a internet network configuration that may be employed to carry out processing functionality, according to some exemplary embodiments of the disclosure.

FIG. 4 depicts a flow chart of an example method 900 comprising implementing a biological computer aided design (BioCAD) tool according to an embodiment of the present disclosure.

Additional explanations are provided within the illustrative examples provided herein.

### DETAILED DESCRIPTION OF THE EMBODIMENTS

In the description that follows, a number of terms used in recombinant nucleic acid technology are utilized extensively. In order to provide a clear and more consistent understanding of the specification and claims, including the scope to be given such terms, the following definitions are provided.

Genomic Products and Services: As used herein, the term genomic products and services refers to products and services that may be used to conduct research involving nucleic acids (DNA/RNA all types).

Proteomic Products and Services: As used herein, the term proteomic products and services refers to products and services that may be used to conduct research involving polypeptides and proteins.

Clone Collection: As used herein, “clone collection” refers to two or more nucleic acid molecules, each of which comprises one or more nucleic acid sequences of interest.

User: As used herein, the term user refers to any individual who uses a software, a computer program, a computer system and/or a BioCAD tool of the present disclosure.

Customer: As used herein, the term customer refers to any individual, institution, corporation, university, or organization seeking to obtain genomic and proteomic products and services.

Provider: As used herein, the term provider refers to any individual, institution, corporation, university, or organization seeking to provide genomic and proteomic products and services.

Subscriber: As used herein, the term subscriber refers to any customer having an agreement with a provider to obtain public and private genomic and proteomic products and services at subscriber rates.

Non-subscriber: As used herein, the term non-subscriber refers to any customer who does not have an agreement with a provider to obtain public and private genomic and proteomic products and services at subscriber rates.

Host: As used herein, the term “host” refers to any prokaryotic or eukaryotic (e.g., mammalian, insect, yeast, plant, avian, animal, etc.) cell and/or organism that is a recipient of a replicable expression vector, cloning-vector or any nucleic acid molecule. The nucleic acid molecule may contain, but is not limited to, a sequence of interest, a transcriptional regulatory sequence (such as a promoter, enhancer, repressor, and the like) and/or an origin of replication. As used herein, the terms “host,” “host cell,” “recombinant host” and “recombinant host cell” may be used interchangeably. For examples of such hosts, see Sambrook, et al., Molecular Cloning: A Laboratory Manual, Cold Spring Harbor Laboratory, Cold Spring Harbor, N.Y.

Transcriptional Regulatory Sequence: As used herein, the phrase “transcriptional regulatory sequence” refers to a functional stretch of nucleotides contained on a nucleic acid molecule, in any configuration or geometry, that act to regulate the transcription of (1) one or more nucleic acid sequences that may comprise ORFs, (e.g., two, three, four, five, seven, ten, etc.) into messenger RNA or (2) one or more nucleic acid sequences into untranslated RNA. Examples of transcriptional regulatory sequences include, but are not limited to, promoters, enhancers, repressors, operators (e.g., the tet operator), and the like.

Promoter: As used herein, a promoter is an example of a transcriptional regulatory sequence, and is specifically a nucleic acid generally described as the 5′-region of a gene located proximal to the start codon or nucleic acid that encodes untranslated RNA. The transcription of an adjacent nucleic acid segment is initiated at or near the promoter. A repressible promoter's rate of transcription decreases in response to a repressing agent. An inducible promoter's rate of transcription increases in response to an inducing agent. A constitutive promoter's rate of transcription is not specifically regulated, though it can vary under the influence of general metabolic conditions.

Insert: As used herein, the term “insert” refers to a desired nucleic acid segment that is a part of a larger nucleic acid molecule. In many instances, the insert will be introduced into the larger nucleic acid molecule using techniques known to those of skill in the art, e.g., recombinational cloning, topoisomerase cloning or joining, ligation, etc.

Target Nucleic Acid Molecule: As used herein, the phrase “target nucleic acid molecule” refers to a nucleic acid molecule comprising at least one nucleic acid sequence of interest, preferably a nucleic acid molecule that is to be acted upon using the compounds and methods of the present disclosure. Such target nucleic acid molecules may contain one or more (e.g., two, three, four, five, seven, ten, twelve, fifteen, twenty, thirty, fifty, etc.) sequences of interest.

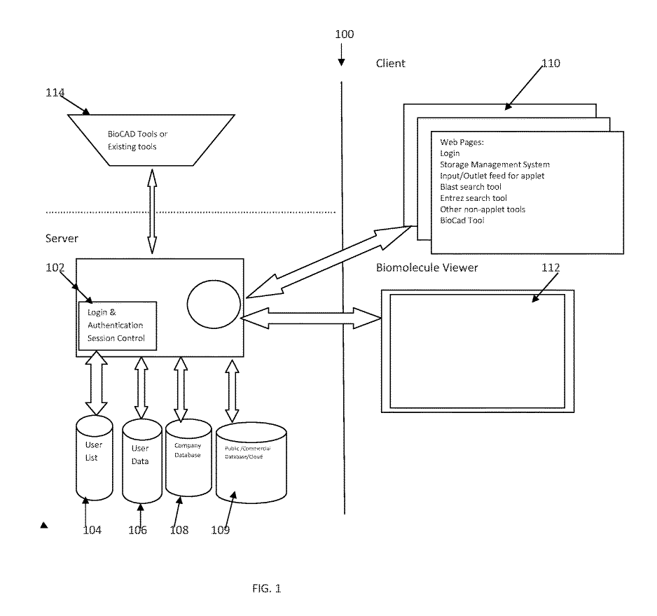

Recognition Sequence: As used herein, the phrase “recognition sequence” or “recognition site” refers to a particular sequence to which a protein, chemical compound, DNA, or RNA molecule (e.g., restriction endonuclease, a topoisomerase, a modification methylase, a recombinase, etc.) recognizes and binds. In the present disclosure, a recognition sequence may refer to a recombination site. For example, the recognition sequence for Cre recombinase is loxP which is a 34 base pair sequence comprising two 13 base pair inverted repeats (serving as the recombinase binding sites) flanking an 8 base pair core sequence (see FIG. 1 of Sauer, B., Current Opinion in Biotechnology 5:521-527 (1994)). Other examples of recognition sequences are the attB, attP, attL, and attR sequences, which are recognized by the recombinase enzyme X Integrase. attB is an approximately 25 base pair sequence containing two 9 base pair core-type Int binding sites and a 7 base pair overlap region. attP is an approximately 240 base pair sequence containing core-type Int binding sites and arm-type Int binding sites as well as sites for auxiliary proteins integration host factor (IHF), FIS and excisionase (Xis) (see Landy, Current Opinion in Biotechnology 3:699-707 (1993)). Such sites may also be engineered according to the present disclosure to enhance production of products, such as biomolecules, in the methods of the disclosure. For example, when such engineered sites lack the P1 or HI domains to make the recombination reactions irreversible (e.g., attR or attP), such sites may be designated attR' or attP' to show that the domains of these sites have been modified in some way.

Recombination Proteins: As used herein, the phrase “recombination proteins” includes excisive or integrative proteins, enzymes, co-factors or associated proteins that are involved in recombination reactions involving one or more recombination sites (e.g., two, three, four, five, seven, ten, twelve, fifteen, twenty, thirty, fifty, etc.), which may be wild-type proteins (see Landy, Current Opinion in Biotechnology 3:699-707 (1993)), or mutants, derivatives (e.g., fusion proteins containing the recombination protein sequences or fragments thereof), fragments, and variants thereof. Examples of recombination proteins include Cre, Int, IHF, Xis, Flp, Fis, Hin, Gin, .PHI.C31, Cin, Tn3 resolvase, TndX, XerC, XerD, TnpX, Hjc, Gin, SpCCE1, and ParA.

Recombinases: As used herein, the term “recombinases” is used to refer to the protein that catalyzes strand cleavage and re-ligation in a recombination reaction. Site-specific recombinases are proteins that are present in many organisms (e.g., viruses and bacteria) and have been characterized as having both endonuclease and ligase properties. These recombinases (along with associated proteins in some cases) recognize specific sequences of bases in a nucleic acid molecule and exchange the nucleic acid segments flanking those sequences. The recombinases and associated proteins are collectively referred to as “recombination proteins” (see, e.g., Landy, A., Current Opinion in Biotechnology 3:699-707 (1993)).

Numerous recombination systems from various organisms have been described. See, e.g., Hoess, et al., Nucleic Acids Research 14(6):2287 (1986); Abremski, et al., J. Biol. Chem. 261(1):391 (1986); Campbell, J. Bacteriol. 174(23):7495 (1992); Qian, et al., J. Biol. Chem. 267(11):7794 (1992); Araki, et al., J. Mol. Biol. 225(1):25 (1992); Maeser and Kahnmann, Mol. Gen. Genet. 230:170-176 (1991); Esposito, et al., Nucl. Acids Res. 25(18):3605 (1997). Many of these belong to the integrase family of recombinases (Argos, et al., EMBO J. 5:433-440 (1986); Voziyanov, et al., Nucl. Acids Res. 27:930 (1999)). Perhaps the best studied of these are the Integrase/att system from bacteriophage .lamda. (Landy, A. Current Opinions in Genetics and Devel. 3:699-707 (1993)), the Cre/loxP system from bacteriophage P1 (Hoess and Abremski (1990) In Nucleic Acids and Molecular Biology, vol. 4. Eds.: Eckstein and Lilley, Berlin-Heidelberg: Springer-Verlag; pp. 90-109), and the FLP/FRT system from the Saccharomyces cerevisiae 2μcircle plasmid (Broach, et al., Cell 29:227-234 (1982)).

Recombination Site: A used herein, the phrase “recombination site” refers to a recognition sequence on a nucleic acid molecule that participates in an integration/recombination reaction by recombination proteins. Recombination sites are discrete sections or segments of nucleic acid on the participating nucleic acid molecules that are recognized and bound by a site-specific recombination protein during the initial stages of integration or recombination. For example, the recombination site for Cre recombinase is loxP, which is a 34 base pair sequence comprised of two 13 base pair inverted repeats (serving as the recombinase binding sites) flanking an 8 base pair core sequence (see FIG. 1 of Sauer, B., Curr. Opin. Biotech. 5:521-527 (1994)). Other examples of recombination sites include the attB, attP, attL, and attR sequences described in U.S. provisional patent applications 60/136,744, filed May 28, 1999, and 60/188,000, filed Mar. 9, 2000, and in co-pending U.S. patent applications Ser. Nos. 09/517,466 and 09/732,91—all of which are specifically incorporated herein by reference—and mutants, fragments, variants and derivatives thereof, which are recognized by the recombination protein .lamda. Int and by the auxiliary proteins integration host factor (IHF), FIS and excisionase (Xis) (see Landy, Curr. Opin. Biotech. 3:699-707 (1993)).

Mutating specific residues in the core region of the att site can generate a large number of different att sites. As with the att I and att2 sites utilized in GATEWAY™, each additional mutation potentially creates a novel att site with unique specificity that will recombine only with its cognate partner att site bearing the same mutation and will not cross-react with any other mutant or wild-type att site. Novel mutated att sites (e.g., attB 1-10, attP 1-10, attR 1-10 and attL 1-10) are described in previous patent application Ser. No. 09/517,466, filed Mar. 2, 2000, which is specifically incorporated herein by reference. Other recombination sites having unique specificity (i.e., a first site will recombine with its corresponding site and will not recombine or not substantially recombine with a second site having a different specificity) may be used to practice the present disclosure. Examples of suitable recombination sites include, but are not limited to, loxP sites; loxP site mutants, variants or derivatives such as loxP511 (see U.S. Pat. No. 5,851,808); frt sites; frt site mutants, variants or derivatives; dif sites; dif site mutants, variants or derivatives; psi sites; psi site mutants, variants or derivatives; cer sites; and cer site mutants, variants or derivatives.

Recombination sites may be added to molecules by any number of known methods. For example, recombination sites can be added to nucleic acid molecules by blunt end ligation, PCR performed with fully or partially random primers, or inserting the nucleic acid molecules into a vector using a restriction site flanked by recombination sites.

Recombinational Cloning: As used herein, the phrase “recombinational cloning” refers to a method whereby segments of nucleic acid molecules or populations of such molecules are exchanged, inserted, replaced, substituted or modified, in vitro or in vivo. Preferably, such cloning method is an in vitro method.

Suitable recombinational cloning systems that utilize recombination at defined recombination sites have been previously described in U.S. Pat. Nos. 5,888,732, 6,143,557, 6,171,861, 6,270,969, and 6,277,608, and in pending U.S. application Ser. No. 09/517,466, and in published United States application no. 20020007051, (each of which is fully incorporated herein by reference), all assigned to the Invitrogen Corporation, Carlsbad, Calif. In brief, the GATEWAY™ Cloning System described in these patents utilizes vectors that contain at least one recombination site to clone desired nucleic acid molecules in vivo or in vitro. In some embodiments, the system utilizes vectors that contain at least two different site-specific recombination sites that may be based on the bacteriophage lambda system (e.g., att1 and att2) that are mutated from the wild-type (att0) sites. Each mutated site has a unique specificity for its cognate partner att site (i.e., its binding partner recombination site) of the same type (for example attB1 with attP1, or attL1 with attR1) and will not cross-react with recombination sites of the other mutant type or with the wild-type att0 site. Different site specificities allow directional cloning or linkage of desired molecules thus providing desired orientation of the cloned molecules. Nucleic acid fragments flanked by recombination sites are cloned and subcloned using the GATEWAY™ system by replacing a selectable marker (for example, ccdB) flanked by att sites on the recipient plasmid molecule, sometimes termed the Destination Vector. Desired clones are then selected by transformation of a ccdB sensitive host strain and positive selection for a marker on the recipient molecule. Similar strategies for negative selection (e.g., use of toxic genes) can be used in other organisms such as thymidine kinase (TK) in mammals and insects.

Topoisomerase recognition site: As used herein, the term “topoisomerase recognition site” means a defined nucleotide sequence that is recognized and bound by a site specific topoisomerase. For example, the nucleotide sequence 5′-(C/T)CCTT-3′ is a topoisomerase recognition site that is bound specifically by most poxvirus topoisomerases, including vaccinia virus DNA topoisomerase I, which then can cleave the strand after the 3′-most thymidine of the recognition site to produce a nucleotide sequence comprising 5′-(C/T)CCTT-PO.sub.4-TOPO, i.e., a complex of the topoisomerase covalently bound to the 3′ phosphate through a tyrosine residue in the topoisomerase (see, Shuman, J. Biol. Chem. 266:11372-11379, 1991; Sekiguchi and Shuman, Nucl. Acids Res. 22:5360-5365, 1994; each of which is incorporated herein by reference; see, also, U.S. Pat. No. 5,766,891; PCT/US95/16099; and PCT/US98/12372). In comparison, the nucleotide sequence 5′-GCAACTT-3′ is the topoisomerase recognition site for type IA E. coli topoisomerase III.

Repression Cassette: As used herein, the phrase “repression cassette” refers to a nucleic acid segment that contains a repressor or a selectable marker present in the subcloning vector.

Selectable Marker: As used herein, the phrase “selectable marker” refers to a nucleic acid segment that allows one to select for or against a molecule (e.g., a replicon) or a cell that contains it, often under particular conditions. These markers can encode an activity, such as, but not limited to, production of RNA, peptide, or protein, or can provide a binding site for RNA, peptides, proteins, inorganic and organic compounds or compositions and the like. Examples of selectable markers include but are not limited to: (1) nucleic acid segments that encode products that provide resistance against otherwise toxic compounds (e.g., antibiotics); (2) nucleic acid segments that encode products that are otherwise lacking in the recipient cell (e.g., tRNA genes, auxotrophic markers); (3) nucleic acid segments that encode products that suppress the activity of a gene product; (4) nucleic acid segments that encode products that can be readily identified (e.g., phenotypic markers such as (beta-galactosidase, green fluorescent protein (GFP), yellow flourescent protein (YFP), red fluorescent protein (RFP), cyan fluorescent protein (CFP), and cell surface proteins); (5) nucleic acid segments that bind products that are otherwise detrimental to cell survival and/or function; (6) nucleic acid segments that otherwise inhibit the activity of any of the nucleic acid segments described in Nos. 1-5 above (e.g., antisense oligonucleotides); (7) nucleic acid segments that bind products that modify a substrate (e.g., restriction endonucleases); (8) nucleic acid segments that can be used to isolate or identify a desired molecule (e.g., specific protein binding sites); (9) nucleic acid segments that encode a specific nucleotide sequence that can be otherwise non-functional (e.g., for PCR amplification of subpopulations of molecules); (10) nucleic acid segments that, when absent, directly or indirectly confer resistance or sensitivity to particular compounds; and/or (11) nucleic acid segments that encode products that either are toxic (e.g., Diphtheria toxin) or convert a relatively non-toxic compound to a toxic compound (e.g., Herpes simplex thymidine kinase, cytosine deaminase) in recipient cells; (12) nucleic acid segments that inhibit replication, partition or heritability of nucleic acid molecules that contain them; and/or (13) nucleic acid segments that encode conditional replication functions, e.g., replication in certain hosts or host cell strains or under certain environmental conditions (e.g., temperature, nutritional conditions, etc.).

Site-Specific Recombinase: As used herein, the phrase “site-specific recombinase” refers to a type of recombinase that typically has at least the following four activities (or combinations thereof): (1) recognition of specific nucleic acid sequences; (2) cleavage of said sequence or sequences; (3) topoisomerase activity involved in strand exchange; and (4) ligase activity to reseal the cleaved strands of nucleic acid (see Sauer, B., Current Opinions in Biotechnology 5:521-527 (1994)). Conservative site-specific recombination is distinguished from homologous recombination and transposition by a high degree of sequence specificity for both partners. The strand exchange mechanism involves the cleavage and rejoining of specific nucleic acid sequences in the absence of DNA synthesis (Landy, A. (1989) Ann. Rev. Biochem. 58:913-949).

Suppressor tRNAs: As used herein, the phrase “suppressor tRNA” refers to a molecule that mediates the incorporation of an amino acid in a polypeptide in a position corresponding to a stop codon in the mRNA being translated.

Homologous Recombination: As used herein, the phrase “homologous recombination” refers to the process in which nucleic acid molecules with similar nucleotide sequences associate and exchange nucleotide strands. A nucleotide sequence of a first nucleic acid molecule that is effective for engaging in homologous recombination at a predefined position of a second nucleic acid molecule will therefore have a nucleotide sequence that facilitates the exchange of nucleotide strands between the first nucleic acid molecule and a defined position of the second nucleic acid molecule. Thus, the first nucleic acid will generally have a nucleotide sequence that is sufficiently complementary to a portion of the second nucleic acid molecule to promote nucleotide base pairing.

Homologous recombination: requires homologous sequences in the two recombining partner nucleic acids but does not require any specific sequences. As indicated above, site-specific recombination that occurs, for example, at recombination sites such as att sites, is not considered to be “homologous recombination,” as the phrase is used herein.

Vector: As used herein, the term “vector” refers to a nucleic acid molecule (preferably DNA) that provides a useful biological or biochemical property to an insert. Examples include plasmids, phages, viruses, autonomously replicating sequences (ARS), centromeres, and other sequences that are able to replicate or be replicated in vitro or in a host cell, or to convey a desired nucleic acid segment to a desired location within a host cell. A vector can have one or more restriction endonuclease recognition sites (e.g., two, three, four, five, seven, ten, etc.) at which the sequences can be cut in a determinable fashion without loss of an essential biological function of the vector, and into which a nucleic acid fragment can be spliced in order to bring about its replication and cloning. Vectors can further provide primer sites (e.g., for PCR), transcriptional and/or translational initiation and/or regulation sites, recombinational signals, replicons, selectable markers, etc. Clearly, methods of inserting a desired nucleic acid fragment that do not require the use of recombination, transpositions or restriction enzymes (such as, but not limited to, uracil N-glycosylase (UDG) cloning of PCR fragments (U.S. Pat. Nos. 5,334,575 and 5,888,795, both of which are entirely incorporated herein by reference), T:A cloning, and the like) can also be applied to clone a fragment into a cloning vector to be used according to the present disclosure. The cloning vector can further contain one or more selectable markers (e.g., two, three, four, five, seven, ten, etc.) suitable for use in the identification of cells transformed with the cloning vector.

Subcloning Vector: As used herein, the phrase “subcloning vector” refers to a cloning vector comprising a circular or linear nucleic acid molecule that includes, preferably, an appropriate replicon. In the present disclosure, the subcloning vector can also contain functional and/or regulatory elements that are desired to be incorporated into the final product to act upon or with the cloned nucleic acid insert. The subcloning vector can also contain a selectable marker (preferably DNA).

Primer: As used herein, the term “primer” refers to a single stranded or double stranded oligonucleotide that is extended by covalent bonding of nucleotide monomers during amplification or polymerization of a nucleic acid molecule (e.g., a DNA molecule). In one aspect, the primer may be a sequencing primer (for example, a universal sequencing primer). In another aspect, the primer may comprise a recombination site or portion thereof.

Adapter: As used herein, the term “adapter” refers to an oligonucleotide or nucleic acid fragment or segment (preferably DNA) that comprises one or more recombination sites (or portions of such recombination sites) that can be added to a circular or linear nucleic acid molecule as well as to other nucleic acid molecules described herein. When using portions of recombination sites, the missing portion may be provided by the nucleic acid molecule. Such adapters may be added at any location within a circular or linear molecule, although the adapters are preferably added at or near one or both termini of a linear molecule. Preferably, adapters are positioned to be located on both sides (flanking) a particular nucleic acid molecule of interest. In accordance with the disclosure, adapters may be added to nucleic acid molecules of interest by standard recombinant techniques (e.g., restriction digest and ligation). For example, adapters may be added to a circular molecule by first digesting the molecule with an appropriate restriction enzyme, adding the adapter at the cleavage site and reforming the circular molecule that contains the adapter(s) at the site of cleavage. In other aspects, adapters may be added by homologous recombination, by integration of RNA molecules, and the like. Alternatively, adapters may be ligated directly to one or more and preferably both termini of a linear molecule thereby resulting in linear molecule(s) having adapters at one or both termini. In one aspect of the disclosure, adapters may be added to a population of linear molecules, (e.g., a cDNA library or genomic DNA that has been cleaved or digested) to form a population of linear molecules containing adapters at one and preferably both termini of all or substantial portion of said population.

Adapter-Primer: As used herein, the phrase “adapter-primer” refers to a primer molecule that comprises one or more recombination sites (or portions of such recombination sites) that can be added to a circular or to a linear nucleic acid molecule described herein. When using portions of recombination sites, the missing portion may be provided by a nucleic acid molecule (e.g., an adapter) of the disclosure. Such adapter-primers may be added at any location within a circular or linear molecule, although the adapter-primers are preferably added at or near one or both termini of a linear molecule. Such adapter-primers may be used to add one or more recombination sites or portions thereof to circular or linear nucleic acid molecules in a variety of contexts and by a variety of techniques, including but not limited to amplification (e.g., PCR), ligation (e.g., enzymatic or chemical/synthetic ligation), recombination (e.g., homologous or non-homologous (illegitimate) recombination) and the like.

Template: As used herein, the term “template” refers to a double stranded or single stranded nucleic acid molecule, all or a portion of which is to be amplified, synthesized, reverse transcribed, or sequenced. In the case of a double-stranded DNA molecule, denaturation of its strands to form a first and a second strand is preferably performed before these molecules may be amplified, synthesized or sequenced, or the double stranded molecule may be used directly as a template. For single stranded templates, a primer complementary to at least a portion of the template hybridizes under appropriate conditions and one or more polypeptides having polymerase activity (e.g., two, three, four, five, or seven DNA polymerases and/or reverse transcriptases) may then synthesize a molecule complementary to all or a portion of the template. Alternatively, for double stranded templates, one or more transcriptional regulatory sequences (e.g., two, three, four, five, seven or more promoters) may be used in combination with one or more polymerases to make nucleic acid molecules complementary to all or a portion of the template. The newly synthesized molecule, according to the disclosure, may be of equal or shorter length compared to the original template. Mismatch incorporation or strand slippage during the synthesis or extension of the newly synthesized molecule may result in one or a number of mismatched base pairs. Thus, the synthesized molecule need not be exactly complementary to the template. Additionally, a population of nucleic acid templates may be used during synthesis or amplification to produce a population of nucleic acid molecules typically representative of the original template population.

Incorporating: As used herein, the term “incorporating” means becoming a part of a nucleic acid (e.g., DNA) molecule or primer.

Library: As used herein, the term “library” refers to a collection of nucleic acid molecules (circular or linear). In one embodiment, a library may comprise a plurality of nucleic acid molecules (e.g., two, three, four, five, seven, ten, twelve, fifteen, twenty, thirty, fifty, one hundred, two hundred, five hundred one thousand, five thousand, or more), that may or may not be from a common source organism, organ, tissue, or cell. In another embodiment, a library is representative of all or a: portion or a significant portion of the nucleic acid content of an organism (a “genomic” library), or a set of nucleic acid molecules representative of all or a portion or a significant portion of the expressed nucleic acid molecules (a cDNA library or segments derived therefrom) in a cell, tissue, organ or organism. A library may also comprise nucleic acid molecules having random sequences made by de novo synthesis, mutagenesis of one or more nucleic acid molecules, and the like. Such libraries may or may not be contained in one or more vectors (e.g., two, three, four, five, seven, ten, twelve, fifteen, twenty, thirty, fifty, etc.). In some embodiments, a library may be “normalized” library (i.e., a library of cloned nucleic acid molecules from which each member nucleic acid molecule can be isolated with approximately equivalent probability).

Normalized: As used herein, the term “normalized” or “normalized library” means a nucleic acid library that has been manipulated, preferably using the methods of the disclosure, to reduce the relative variation in abundance among member nucleic acid molecules in the library to a range of no greater than about 25-fold, no greater than about 20-fold, no greater than about 15-fold, no greater than about 10-fold, no greater than about 7-fold, no greater than about 6-fold, no greater than about 5-fold, no greater than about 4-fold, no greater than about 3-fold or no greater than about 2-fold.

Amplification: As used herein, the term “amplification” refers to any in vitro method for increasing the number of copies of a nucleic acid molecule with the use of one or more polypeptides having polymerase activity (e.g., one, two, three, four or more nucleic acid polymerases or reverse transcriptases). Nucleic acid amplification results in the incorporation of nucleotides into a DNA and/or RNA molecule or primer thereby forming a new nucleic acid molecule complementary to a template. The formed nucleic acid molecule and its template can be used as templates to synthesize additional nucleic acid molecules. As used herein, one amplification reaction may consist of many rounds of nucleic acid replication. DNA amplification reactions include, for example, polymerase chain reaction (PCR). One PCR reaction may consist of 5 to 100 cycles of denaturation and synthesis of a DNA molecule.

Nucleotide: As used herein, the term “nucleotide” refers to a base-sugar-phosphate combination. Nucleotides are monomeric units of a nucleic acid molecule (DNA and RNA). The term nucleotide includes ribonucleoside triphosphates ATP, UTP, CTG, GTP and deoxyribonucleoside triphosphates such as dATP, dCTP, dITP, dUTP, dGTP, dTTP, or derivatives thereof. Such derivatives include, for example, [.alpha.-S]dATP, 7-deaza-dGTP and 7-deaza-dATP. The term nucleotide as used herein also refers to dideoxyribonucleoside triphosphates (ddNTPs) and their derivatives. Illustrated examples of dideoxyribonucleoside triphosphates include, but are not limited to, ddATP, ddCTP, ddGTP, ddITP, and ddTTP. According to the present disclosure, a “nucleotide” may be unlabeled or detectably labeled by well known techniques. Detectable labels include, for example, radioactive isotopes, fluorescent labels, chemiluminescent labels, bioluminescent labels and enzyme labels.

Nucleic Acid Molecule: As used herein, the phrase “nucleic acid molecule” refers to a sequence of contiguous nucleotides (riboNTPs, dNTPs, ddNTPs, or combinations thereof) of any length. A nucleic acid molecule may encode a full-length polypeptide or a fragment of any length thereof, or may be non-coding. As used herein, the terms “nucleic acid molecule” and “polynucleotide” may be used interchangeably and include both RNA and DNA.

Oligonucleotide: As used herein, the term “oligonucleotide” refers to a synthetic or natural molecule comprising a covalently linked sequence of nucleotides that are joined by a phosphodiester bond between the 3′ position of the pentose of one nucleotide and the 5′ position of the pentose of the adjacent nucleotide. \

Open Reading Frame (ORF): As used herein, an open reading frame or ORF refers to a sequence of nucleotides that codes for a contiguous sequence of amino acids. ORFs of the disclosure may be constructed to code for the amino acids of a polypeptide of interest from the N-termius of the polypeptide (typically a methionine encoded by a sequence that is transcribed as AUG) to the C-terminus of the polypeptide. ORFs of the disclosure include sequences that encode a contiguous sequence of amino acids with no intervening sequences (e.g., an ORF from a cDNA) as well as ORFs that comprise one or more intervening sequences (e.g., introns) that may be processed from an mRNA containing them (e.g., by splicing) when an mRNA containing the ORF is transcribed in a suitable host cell. ORFs of the disclosure also comprise splice variants of ORFs containing intervening sequences.

ORFs may optionally be provided with one or more sequences that function as stop codons (e.g., contain nucleotides that are transcribed as UAG, an amber stop codon, UGA, an opal stop codon, and/or UAA, an ochre stop codon). When present, a stop codon may be provided after the codon encoding the C-terminus of a polypeptide of interest (e.g., after the last amino acid of the polypeptide) and/or may be located within the coding sequence of the polypeptide of interest. When located after the C-terminus of the polypeptide of interest, a stop codon may be immediately adjacent to the codon encoding the last amino acid of the polypeptide or there may be one or more codons (e.g., one, two, three, four, five, ten, twenty, etc) between the codon encoding the last amino acid of the polypeptide of interest and the stop codon. A nucleic acid molecule containing an ORF may be provided with a stop codon upstream of the initiation codon (e.g., an AUG codon) of the ORF. When located upstream of the initiation codon of the polypeptide of interest, a stop codon may be immediately adjacent to the initiation codon or there may be one or more codons (e.g., one, two, three, four, five, ten, twenty, etc) between the initiation codon and the stop codon.

Polypeptide: As used herein, the term “polypeptide” refers to a sequence of contiguous amino acids of any length. The terms “peptide,” “oligopeptide,” or “protein” may be used interchangeably herein with the term “polypeptide.”

Hybridization: As used herein, the terms “hybridization” and “hybridizing” refer to base pairing of two complementary single-stranded nucleic acid molecules (RNA and/or DNA) to give a double stranded molecule. As used herein, two nucleic acid molecules may hybridize, although the base pairing is not completely complementary. Accordingly, mismatched bases do not prevent hybridization of two nucleic acid molecules provided that appropriate conditions, well known in the art, are used. In some aspects, hybridization is said to be under “stringent conditions.” By “stringent conditions,” as the phrase is used herein, is meant overnight incubation at 42.degree. C. in a solution comprising: 50% formamide, 5.times.SSC (750 mM NaCl, 75 mM trisodium citrate), 50 mM sodium phosphate (pH 7.6), 5.times. Denhardt's solution, 10% dextran sulfate, and 20 .mu.g/m1 denatured, sheared salmon sperm DNA, followed by washing the filters in 0.1.times.SSC at about 65.degree. C.

Feature: As used herein, the term “feature” refers to a segment of a biomolecule that provides a specific function. For example, a “feature” can be a region of a polypeptide or polynucleotide that has a specific function. In an illustrative example, a feature is a region of a vector that has a specific function. For example, a feature on a vector includes, but is not limited to, a restriction enzyme site, a recombination site, or a tag-encoding sequence.

An exemplary list of vectors that can be used in the in silico design methods, includes the following: BaculoDirect Linear DIMA; BacuiloDirect Linear; DNA Cloning Fragment DNA; BaculoDirect N-term Linear DNA_verA; BaculoDirect™ C-Term Baculovirus Linear DNA; BaculoDirect™ N-Term Baculovirus Linear DNA; Champion™ pET100/D-TOPO® ; Champion™ pET 101/D-TOPO® ; Champion™ pET 102/D-TOPO® ; Champion™ pET 104/D-TOPO® ; Champion™ pET104-DEST; Champion™ pET151/D-TOPO.COPYRGT.; Champion™ pET 160/D-TOPO® ; Champion™ pET 160-DEST; Champion™ pET 161-DEST; Champion™ pET200/D-TOPO® ; pAc5.1N5-His A, B, and C; pAd/BLOCK-iT-DEST; pAd/BLOCK-f!.“-DEST_verA_sz; pAd/CMVA/5 DEST; pAd/PL-DEST; pAO815; pBAD/g111 A, B, and C; pBAD/His A, B, and C; pBAD/myc-His A, B, and C; pBAD/Thio-TOPO® ; pBAD 102/D-TOPO® ; pBAD20/D-TOPO® ; pBAD202/D-TOPO® ; pBAD DEST49; PBAD-TOPO; PBAD-TOPO®; pBC1; pBLOCK-fT3-DEST pBLOCK-iT6-DEST pBlueBac4.5 pBlueBac4.5A/5-His TOPO® ; pBlueBacHis2 A, B, and C; pBR322; pBudCE4.1; pcDN3.1A/5-His-TOPO; pcDNA3.1(−); pcDNA3.1(+); pcDNA3.1(+)/myc-HisA; pcDNA3.1(+)/myc-His A, B, C; pcDNA3.1(+)/myc-His B; pcDNA3.1(+)/myc-HisC; DCDNA3.1/CT-GFP-TOPO; pcDNA3.1/His A; pcDNA3.1/His B; pcDNA3.1/His C; pcDNA3.1/Hygro(-); pcDNA3.1/Hygro(+); pcDNA3.1/NT-GFP-TOPO; pcDNA3.1/nV5-DEST; pcDNA3.1A/5-His A; pcDNA3.1A/5-His B; pcDNA3.1A/5-His C; pcDNA3.1/Zeo(−); pcDNA3.1/Zeo(+); pcDNA3.1/Zeo(+); pcDNA3.1DA/5-His-TOPO; pcDNA3.2N5-DEST; pcDNA3.2A/5-GW/D-TOPO; pcDNA3.2-DEST; pcDNA4/His A; pcDNA4/His B; pcDNA4/His C; pcDNA4/HisMAX A, B & C; pcDNA4/HisMax-TOPO; pcDNA4/HisMax-TOPO; pcDNA4/myc-His A, B, and C; pcDNA4/TO; pcDNA4/TO; pcDNA4/TO/myc-His A; pcDNA4/TO/myc-His A, B, C; pcDNA4/TO/myc-His B; pcDNA4/TO/myc-His C; pcDNA4N5-His A, B, and C; pcDNA5/FRT; pcDNA5/FRT; pcDNA5/FRT/TO/CAT; pcDNA5/FRT/TO-TOPO; pcDNA5/FRT/V5-His-TOPO; pcDNA5/TO; pcDNA6.2/cGeneBLAzer-DEST_verA_sz; pcDNA6; 2/cGeneBLAzer-GW/D-TOPO pcDNA6; 2/cGeneBlazer-GW/D-TOPO_verA_sz pcDNA6.2/cLumio-DEST; pcDNA6 2/cLumio-DE STverAsz pcDNA6.2/GFP-DEST_verA_sz; pcDNA6.2/nGeneBLAzer-DEST pcDNA6 2/nGeneBLAzer-DEST_verA_sz pcDMA6 2/nGeneBlazer-GW/D-TOPO_verA_s2 pcDNA6.2/nLumio-DEST; pcDNA6 2/nLumio-DEST_verB_sz ;pcDNA6.2A/5-DEST pcDNA6.2A/5-GW/D-TOPO pcDNA6/BioEase-DEST verAsz; pcDNA6/H62His A, B, and C pcDNA6/His A, B, and C; pcDNA6/TR; pcDNA6/V5-His A; pcDNA6/V5-His B; pcDNA6/V5-His C; pcDNA6N5-His C; pcDNA-DEST40; pcDNA-DEST47; pcDNA-DEST53; pCEP4; pCEP4/CAT; pCMV/myc/cyto; pCMV/myc/ER; pCMV/myc/mito; pCMV/myc/nuc; pCMVSPORT6 Notl-Sall Cut; pCoBlasi; pCR Blunt; pCR XL TOPO; pCR® T7/CT TOPO® ; pCR® T7/NT TOPO® ; pCR2.1-TOPO; pCR3.1; pCR3.1-Uni; pCR4BLUNT-TOPO; pCR4-TOPO; pCR8/GW/TOPO TA; pCR8/GW-TOPO_verA_sz; pCR-Blunt II-TOPO;-pCRII-TOPO; pDEST™ R4-R3; PDEST™10; PDEST™14; PDEST™15; pDEST™17; pDEST™20; pDEST™22; PDEST™24; pDEST™26; pDES™27; pDEST™32; pDEST™8; pDEST™38; pDEST™39; pDisplay; pDONR™P2R P3; PDONR™P2R-P3; pDONR™P4-P1R; pDONR™P4-P1R; pDONR™/Zeo; pDONR™/Zeo; pDONR™201; pDONR™201; pDONR™207; pDONR™207; pDONR™221; pDONR™221; pDONR™222; pDONR™222; pEF/myc/cyto; pEF/myc/mito; pEF/myc/nuc; pEFi/His A, B, and C; pEF1/myc-His A, B, and C; pEF1/V5-HisA, B,andC; pEF4/myc-His A, B, and C; pEF4N5-His A, B, and C; pEF5/FRT V5 D-TOPO; pEF5/FRT/V5-DEST™; pEF6/His A, B, and C; pEF6/myc-His A, B, and C; pEF6/V5-His A, B, and C; pEF6A/5-His-TOPO; pEF-DEST51; pENTR U6_verA_sz; pENTR/HirTO_verA_sz; pENTR-TEV/D-TOPO; pENTR™/D-TOPO; pENTR™/D-TOPO; pENTR™/SD/D-TOPO; pENTR™/SD/D-TOPO; pENTR™/TEV/D-TOPO; pENTR™11; pENTR™1A; pENTR™2B; pENTR™3C; pENTR™4; pET SUMO_verA_sz; pET104.1-DEST_verA_sz ; pET104-DEST; pET 160/GW/D-TOPO_verA sz pET160-DEST_verA_sz; pET161 D-TOPO; pET 161/G W/D-TOPO_verA_sz; pET161-DEST_verA_sz; pEXPi-DEST pEXP2-DEST pEXP3-DEST; pEXP3-DEST_vefA_sz; pEXP-AD502 pFastBac Dual pFastBad pFastBacHTA pFastBacHT B pFaslBacHT C; pFLDa; pFliTrx; pFRT/lacZeo; pFRT/lacZeo, pOG44, pcDNA5/FRT; pFRT/lacZeo2; pGAPZ A, B, and C; pGAPZa A, B. and C; pGene/V5-His A, B, and C; pGeneBLAzer-TOPO; pGeneBLAzer-TOPOverA sz; pGlow-TOPO; pH)1_-D2; pHIL-S1; pHybLex/Zeo; pHyBLex/Zeo-MS2; pIB/His A, B, and C; pIBA/5-His Topo; pIBA/5-His-DEST; plBA/5-His-TOPO; plZA/5-His; p!ZT/V5-His; pl_en!i4 BLOCK-iT-DEST; pLenti4/BLOCK-iT-DEST; pLenti4/TOA/5-DEST; pLenti4/TOA/5-DEST_verA sz; pLenti4A/5-DEST; pLen114.”/5-DEST verA_sz; pLenti6/BLOCK-tT-DEST; pl_entiS/BLOCK-iT-DEST_verA_sz; pLenti6/UbCA/5-DEST; pLenti6/UbC/vSDEST_verA_sz; pLenli6A/5-DEST; pLen!i6A/5-D-TOPO; plex; pMelBac A, B, and C; pMET A, B, and C; pMETa A, B, C; pMIBA/5-His A, B, and C; pMIBA/5-His/CAT; pMT/BioEase-DESTverAsz; pMT/BioEase™-DEST; pMT/BioEase™-DEST; pMT/BiPA/5-His A, B, and C; pMT/V5-His A, B, and C; pMT/V5-His-TOPO; pMT-DEST™48; pNMT; pNMT1-TOPO; pNMT41-TOPO; pNMT81-TOPO; pOG44; pPIC3.5K; pPIC6 A, B, and C; pPIC6a A, B, and C; pPICZ A; pPICZ B; pPICZ C; pPICZalpha A; pPICZalpha B; pPICZalpha C; pREP4; pRH3; pRH5.sup.f; pRSET; pSCRE EN-iT/lacZ-DEST_verA_sz; pSecTag/FRTA/5-His TOPO; pSecTag2 A, B, and C; pSecTag2/Hygro A, B, and C; pSH18-34; pThioHis A, B, and C; pTracer-CMV/Bsd; pTracer-CMV2; pTracer-EF A, B, and C; pTracer-EF/Bsd A, B, and C; pTracer-SV40; pTrcHis A, B. and C; pTrcHis2 A, B, and C; pTrcHis2-TOPO® ; pTrcHis2-TOPO® ; pTrcHis-TOPO® ; pT-Rex-DEST30; pT-Rex-DEST30; pT-Rex-DEST™31; pT-REx™-DEST31; pUB/BSD TOPO; pUB6A/5-His A, B, and C; pUC18; pUC19; pUniN5 His TOPO; pVAX1; pVP22/myc-His TOPO® ; pVP22/myc-His2 TOPO® ; pYC2.1-E; pYC2/CT; pYC2/Nt A, B. C; pYC2-E; pYC6/CT; pYD1; pYES2; pYES2.1A/5-His-TOPO; pYES2/CT; pYES2/NT; pYES2/NT A, B, & C; pYES3/CT; pYES6/CT; pYES-DEST™52; pYESTrp; pYESTrp2; pYESTrp3; pZeoSV2(−); pZeoSV2(+); pZErO-1; pZErO-2.

Some terms used to describe various synthetic biology methods and tools described and developed herein are set forth in this section. “Design” is making something new such as making a new biomolecule, a new experimental method, and/or a new biological workflow. “Refactoring” or “re-designing” is redeveloping and modifying an existing biological molecule or a previously designed synthetic molecule.

Various terms are used to describe structures of biomolecules or biomolecular aggregates that can be designed or redesigned by the computer methods and BioCAD tools described herein. Typically short, functional defined pieces or fragments of nucleic acids (DNA/RNA) and or proteins are referred to as “parts.” Parts are generally available in databases such as GenBank, EBI, DDBJ, Expassy, and other public and private protein and/or nucleic acid collections including commercial or company based databases. Parts are classified based upon their functional roles, such as but not limited to “promoters”, “terminators” and/or “coding sequences” for nucleic acid (NA) parts. Some exemplary protein “parts” may include proteins or peptides with functional domains, peptides with specific structure, structural motifs, specific amino acid sequence domains that are associated with specific interactions with other molecules, catalytic subunits, DNA/RNA binding domains, transmembrane domains. Parts are characterized in standardized assays, permitting comparative analysis of the performance of each instance of a part type. Based upon data from standardized assays “parts” can be characterized. This can permit a user to constrain the development of a new design by using Parts that meet certain specifications or constraints.

Parts can be assembled into “devices.” “Devices” are equivalent to genes or operons, typically acting as a means of expressing transcribed, translatable or transcribed, non-translatable products. “Devices” for proteins may comprise proteins including complete functional proteins, enzymes, recombination proteins, receptors, transporters, DNA binding proteins, RNA binding proteins, fusion proteins, and other proteins that can be either derived from native wild type proteins, synthetic redesigned derivatives of native proteins or novel synthetic proteins. Like parts, devices can be both classified and characterized by standardized assays.

“Circuits” represent the interaction of one or more devices with pools of molecules present in an environment, including both in vitro or in vivo environments (test tube, buffer, cell, etc.) or in any synthetic device. Circuits can be classified and characterized as well. By using a standardized method of encoding classification and characterization knowledge about Parts, Devices and Circuits, users using a computer program of the disclosure for BioCAD and/or using a method of the present disclosure can build up data on how to combine these elements into working constructs, how to assess such constructs for design issues and how to screen such constructs for assembly or interaction issues involving a host genome when a construct is to be expressed in a host cell. In addition, BioCAD tools, programs and methods of the present disclosure can be used in refactoring biomolecules which can be used to improve exiting designs which currently have performance issues to have a better performing design and/or to simplify an existing biological sequence and/or a biological system to a simpler version.

Parts, Devices and Circuits can be assembled together to create a Composite Part, Device or Circuit. One non-limiting example of a Composite Part would be the assembly of an N-terminal expression tag, one or more sequences corresponding to functional domains, and a C-terminal experimental tag to create a Composite Coding Sequence. This approach can be applied to creation of Composite parts for all types of parts.

A Composite Device Example includes the assembly of different Parts to create Devices with similar functional configurations but different control configurations. One non-limiting example of a Composite Device is the development of a tetR DNA binding domain controlled reporter device where each device has the functional configuration of controlling transcription of the same reporter molecule but each device is controlled by use of different DNA binding proteins binding to different DNA binding sites incorporated within the promoter within each device exemplar. An example of a Composite Circuit includes the use of different Device combinations to create Circuits with similar functional configurations but different control configurations.

A “data model” is a representation of data collected by a user (or a plurality of users) and is used by one or more BioCAD tools, programs and workflows of the present disclosure. A database of a computer system used typically contains information about natively occurring biomolecules as well as synthetically engineering biomolecules and also contains information regarding data associated with these biomolecules, such as but not limited to, representation of nucleic acid/amino acid sequence information, annotation information and functional classification information.

A data model is used to retrieve, store, manage, create and modify additional information, called MetaData, about the data collected by a user and used by one or more BioCAD tools, programs and workflows of the present disclosure. A database of a computer system used contains information on each biomolecule including but not limited to the origin of the biomolecule of interest with respect to other biomolecules, analysis performed upon the biomolecule, results of analysis, inherent biological and biochemical properties of the biomolecule's sequence or structural properties, interaction data about the biomolecule of interest, such as DNA binding properties or catalytic properties or other biological functions, experimental constraints, experimental usage limitations or requirements, literature references, intellectual property data, originating laboratories and investigators, and other such data, typically referred to as metadata can also be represented and managed within the data model.

A data model is capable of storing information about parts, Composite parts and their associated data and metadata. A data model is capable of storing information about Devices, Composite Devices and their associated data and metadata. A data model is capable of storing information about Circuits, Composite Circuits and their associated data and metadata. A data model is capable of storing information about Hosts, Host derivatives such as Strains and their associated data and metadata. A data model is capable of storing information about Interactions and their associated data and metadata. A data model is capable of storing information about Assays and their associated data and metadata.

Other terms used in the fields of synthetic biology, recombinant nucleic acid technology and molecular and cell biology as used herein will be generally understood by one of ordinary skill in the applicable arts.

The present disclosure is directed to biological computer aided design tools and solutions comprising computer systems, computer software, computer tools and to computer implemented methods including but not limited to, methods for in silico design (e.g., of biomolecules, of biological experiments, of biological workflows), methods of collection and management of biological data, methods of analysis of biological data, and/or to methods for ordering materials and methods of executing in vitro experiments based on in silico designed methods.

The present disclosure, in some embodiments, comprises the development of computer program comprising one or more biological computer aided design (BioCAD) tools (also referred to as a BioCAD tool) and one or more data models to provide an integrated bioinformatics based solution for one or more methods such as but not limited to in silico designing of biomolecules; and/or in silico designing of biological experiments; and/or in silico designing of workflows; in silico refactoring of existing designs of biomolecules or exsiting designs of biological experiments; and/or in silico analysis of various biomolecules and/or in silico analysis of various biological experiments.

In some embodiments, the present disclosure provide an integrated bioinformatics solution that enables a user or a plurality of users to perform one or more of the following methods, including but not limited to: in silico collection and management of biological data; in silico analysis of biological data with software tools (e.g., to discover new information from a set of biological data); and/or ability to design new biomolecules in silico; and/or ability to redesign or refactor an existing biomolecule(s) in silico; and/or in silico ability to design and simulate performance of experimental tools, and/or in silico ability to design and simulate performance of reagents and/or of designed biomolecules (e.g., such as clones, vectors, proteins, chimeras, etc., designed and/or derived from a user created/obtained data);and/or both in silico and in vitro ability to confirm, verify and/or validate the performance of user designed experimental systems and/or workflows; and the ability to order and receive (i.e., purchase online and receive) reagents, biomolecules and other experimental supplies based on in silico design for performing in vitro or in vivo experiments; and/or the ability to reuse existing CAD tools, experimental tools, biomolecules (e.g. clones) and/or reagents.

The present disclosure, in some embodiments, comprises a computer program comprising a combination of at least one data model and at least one biological computer aided design (BioCAD) tool (also referred to herein as a BioCAD tool) that allows a user to design a new biomolecule; and/or to refactor an existing biomolecule; and/or to refactor a designed biomolecule; such that the computer program enables a user determine one or more of the following including: a) if the designed and/or refactored biomolecule is compatible with an in vivo environment that it has been designed for; and/or b) to identify potential errors in silico prior to development work in vivo or in vitro; and/or c) to resolve potential errors in silico prior to development work in vivo or in vitro. In some embodiments, one or more BioCAD tools and one or more data models of the computer program of the disclosure can manage design development of the biomolecule and incorporate experimental data (from other sources such as databases having scientific information relating to experimental data or scientific data about the designed/refactored biomolecule or about parts comprising the designed/refactored biomolecule) as part of information used for the design and/or the refactoring of biomolecules; and/or d) how a designed molecule may interact with other molecules in an in vivo or in vitro environment. In some embodiments, a data model of the computer program can manage the development of a designed or a refactored biomolecule(s) using synthetic biology engineering principles.

Existing computer programs used for designing biomolecules are limited in their ability to build in silico designed biomolecule by stitching together existing biomolecule parts. However, they are unable to provide a user any indication of whether such a designed molecule can or will function in a biological environment. A computer program, according to the present disclosure, is able to access data models during the method of in silico designing and obtain information about user selected “parts”, “devices” and/or “circuits” and manage the designing method such that the designed (or refactored) biomolecule can be analyzed by the program based on the data model and the computer program can then provide the user information about the ability of the designed (or refactored) biomolecule to function in an in vivo or in vitro environment.

In one illustrative example, a data model can access data on how various “parts,” “devices” or “circuits” selected by a user that would form a designed biomolecule would function in a biological environment. In another example, the computer program of the disclosure can provide a user information on what an ideal biological environment should be for a designed biomolecule e.g., what host cell/cell/other molecules may interact with the designed (or refactored) biomolecule.

Data models of the disclosure are based on databases having information on various “parts,” “devices,” “circuits,” other molecules that interact with parts, devices circuits and versions of native biomolecule, previously designed biomolecules, as well as their currently known in vivo and/or in silico properties. These data models can be pre-populated and/or populated as a design/experiment is ongoing.

In some embodiments, a computer program of the present disclosure can provide a user an indication of potential problems associated with the design or refactoring of a biomolecule. The software assisted design methods of the present disclosure are also able to anticipate how a designed molecule will function in an in vivo environment, for example in a cell, and/or while interacting with other biomolecules in an in vivo environment and provide a user with that information. As user can then decide if the performance of the designed molecule is as desired and if not, a user can then re-design changing parameters indicated by the software as being possible problems.

The present disclosure, in some embodiments, therefore comprises a computer program for biological computer aided design (BioCAD) to provide integrated bioinformatics solutions for many bioinformatics methods including non limiting examples such as in silico designing of biomolecules or in silico designing of biological experiments and/or in silico designing of biological workflows; in silico refactoring of existing designs; and/or analysis of various biomolecules and/or analysis of various biological experiments.

In some embodiments, a computer program of the disclosure comprises one or more data models and one or more BioCAD tools, wherein the computer program comprises a non-transitory computer-readable storage medium encoded with instructions for implementing the one or more a BioCAD tools and instructions for accessing or obtaining data from the one or more data models.

In one embodiment, a computer program of the present disclosure, comprising at least one data model and at least one tool, comprises one or more of the following: a) a data model to manage the development of designed or refactored biomolecules using synthetic biology engineering principles; b) tools to enable the design of Parts, Devices and Circuits from existing biomolecules; c) tools to enable the refactoring of Parts, Devices and circuits from existing biomolecules or designed constructs; d) tools to scan, design and refactor transcriptional, translational properties of designed or refactored biomolecules; e) tools to scan, design and refactor cloning approaches that are compatible with the chosen host system; f) tools to identify and resolve potential errors in silico prior to development work in vivo or in vitro; g) tools and a data model to manage and incorporate experimental data as part of design and refactoring of biomolecules; and h) tools and a data model to manage projects containing both designed and refactored biomolecules with their associated native biomolecules or systems.

Some example embodiments below are described with respect to nucleic acid sequences. However, in light of this disclosure, one of skill in the art will appreciate that similar in silico methods can be enabled by a computer method of the disclosure for peptides, proteins and other biological molecules as well.

In some embodiments, a computer program of the disclosure, enables a nucleic acid sequence such as a DNA sequence (or an RNA sequence) to be identified as a Part with an identified functional role and associated biological, experimental and usage metadata. This includes the representation of Parts and part metadata in a data model.

In some embodiments, a computer program of the disclosure enables a nucleic acid sequence such as a DNA sequence (or an RNA sequence) to be identified as a Device with an identified functional role and associated biological, experimental and usage metadata. This includes the representation of devices and device metadata in a data model.

In some embodiments, a computer program of the disclosure enables enables a nucleic acid sequence such as a DNA sequence (or an RNA sequence) to be identified as a Circuit with an identified functional role and associated biological, experimental and usage metadata. This includes the representation of Circuits and Circuit metadata in a data model.

In some embodiments, a computer program of the disclosure enables the definition and use of one or more Small Molecules with identified functional role and associated biological, experimental and usage metadata. This includes the representation of Small Molecules and Small Molecule metadata in a data model.

In some embodiments, a computer program of the disclosure enables the definition and use of interactions between native Biomolecules, Small Molecules, Parts, Devices and Circuits with identified functional role and associated biological, experimental and usage metadata. This includes the representation of interactions and interaction metadata in a data model.

In some embodiments, a computer program of the disclosure enables identification of a Host with associated biological properties and associated biological, experimental and usage metadata. This includes the representation of Hosts and Host metadata in a data model.

In some embodiments, a computer program of the disclosure enables the identification of an Assay with associated experimental properties and results and associated biological, experimental and usage metadata. This includes the representation of Assays and Assay metadata in a data model. This includes the experimental results derived from measurement of specified Parts, Devices, Circuits, Hosts and Small Molecules in the Assay.

In some embodiments, a computer program of the disclosure enables the development, use and management of collections of Small Molecules, Parts, Devices, Circuits, Hosts and Experimental Assay data.

In some embodiments, a computer program of the disclosure enables the use of icons to graphically depict a nucleic acid sequence such as a DNA sequence (or an RNA sequence) based upon functional roles. Icons can be used to depict Parts, Devices, Circuits, Small Molecules. Icons can also be used to depict the interactions between parts, Devices, Circuits, and Small Molecules.

In some embodiments, a computer program of the disclosure enables a user to build parts, devices, and circuits through bottom up design, where the user assembles a Part, Device or Circuit through selection of specific nucleic acid elements (such as DNA or RNA or nucleotides or specific nucleotide sequences or nucleotide motifs).

In some embodiments, a computer program of the disclosure enables a user to build parts, devices and circuits through use of top down design, where the user assembles a part, device or Circuit based upon desired performance of the host system and the computer software uses the functional, biological, experimental and usage metadata as a means to design solutions in either an automated or semi-automated fashion.

In some embodiments, a computer program of the disclosure enables a user to collect and manage experimental data associated with the performance of parts, Devices and Circuits in Assays. This information may be used to guide the development of Parts, Devices and Circuits based upon the performance of these biomolecules in in vitro or in vivo or in silico Assays.

In some embodiments, a computer program of the disclosure enables a user to develop projects for different investigation needs which are populated with Parts, Devices and Circuits. Such projects may be created, modified and stored and retrieved at the user's convenience. Some projects can consist of Part, Device or Circuit development. Some projects can consist of part, device or circuit refactoring. Some projects can consist of management of collections of parts, devices and circuits. Some projects can consist of simulation of parts, devices and circuits. Some projects can consist of modeling of experimental data derived from parts, devices and circuits. Some projects can consist of experimental validation of parts, devices and circuits. Some projects can consist of experimental verification of parts, devices and circuits. Experimental verification in general will be by in vitro methods, although in silico verification can also be performed.

In some embodiments, a computer program of the disclosure enables a user to design biomolecules with desired transcriptional and translational properties, including for example one or more of the following: identification or ribosome binding motifs, promoter binding motifs, secondary structure and optimization of codon usage.

In some embodiments, a computer program of the disclosure enables a user to refactor biomolecules with desired transcriptional and translational properties, including for example one or more of the following: identification or ribosome binding motifs, promoter binding motifs, secondary structure and optimization of codon usage.

In some embodiments, a computer program of the disclosure enables a user to identify potential design problems for a biomolecule within a targeted host, including one or more of the following: presence of undesirable restriction sites, methylation sites, DNA/RNA/nucleic acid/ amino acid/ peptide/protein sequences that should be avoided within a designed or refactored biomolecule, or nucleic acid/amino acid sequences that must be present within a designed or refactored biomolecule.

In some embodiments, a computer program of the disclosure enables a user to identify problems for a biomolecule within a targeted cloning approach, and the problems include for example: presence of undesirable restriction sites, methylation sites, nucleic acid sequences that should be avoided within a designed or refactored biomolecule, or nucleic acid sequences that must be present within a designed or refactored biomolecule

In some embodiments, a computer program of the disclosure enables a user to simulate the cloning of a designed or refactored biomolecule with one or more cloning approaches. This includes use of Type I, Type II, Type IIS and Type IIG restriciton enzyme based cloning approaches; use of recombination based cloning approaches such as Gateway® Cloning; use of homology based cloning approaches such as Gibson Assembly® or GeneArt® seamless cloning; and custom cloning approaches identified by one or more users. Users are able to identify and resolve potential cloning problems in silico and correct these. Users are able to generate information on reagents needed for the methods, designed constructs they will generate and validation information they can generate experimentally to validate their planned constructs.

In some embodiments, a computer program of the disclosure enables a user to associate or to correlate a designed or a refactored biomolecule with an original biomolecule, including a DNA sequence, RNA sequence, Protein sequence, Host genome sequence or analysis result based upon the original biomolecule.

In some embodiments, a computer program of the disclosure enables the representation of a Part in its data model such that individual parts are associated.

In some embodiments, a computer program of the disclosure enables sharing of data and projects among a plurality of users. This can include sharing of data through published or proprietary data formats as files or electronic data. This can include sharing of data computationally through desktop, shared database and cloud based software solutions. This can include sharing of data with robotic systems for semi-automated or automated assembly of designed or refactored biomolecules with associated experimental instructions.

In some embodiments, a computer program of the disclosure enables the identification, design and purchasing of materials and reagents for in vivo and in vitro experiments. This includes the procurement of standard materials such as enzymes, kits, vectors, and other materials with an assigned catalogue number. This includes the purchase of custom materials purchased through a services, such as oligonucleotides, gene synthesis and other non-catalogue materials.

In some embodiments, a computer program of the disclosure enables the development of collections of Parts, Devices, Circuits, hosts and Assays. Such collections can be visualized, organized, queried and otherwise manipulated in a customizable fashion by the user. Collections can be organized upon characteristics of their metadata, including functional, biological, informational, experimental and other metadata associated with the elements within the collection.

In some embodiments, a computer program of the disclosure enables the development of variants that satisfy design constraints for Part, Device or Circuit development. Variants can be associated with design constraints, with projects or with collections of Parts, Devices and Circuits.

In some embodiments, a computer program of the disclosure provides easy access to tools and software to enable design and refactoring of parts, Devices, Circuits, Hosts. This includes basic sequence analysis tools, tools for scanning or design or refactoring of transcriptional or translational properties, tools for visualization and manipulation of visualized data, tools for cloning tools for sharing or storage of projects and tools for ordering and procurement.

In some embodiments, a computer program of the disclosure provides easy access to tools to graphically manipulate or characterize parts, devices, circuits, small molecules and hosts. This includes tools to standardize display of parts, devices, circuits and small molecules; tools to customize the display of parts, devices, circuits and small molecules; tools to publish the display of display of parts, devices, circuits and small molecules.

In some embodiments, a computer program of the disclosure provides easy access to tools to define interactions between biomolecules from the host as well as between Parts, Devices, Circuits, Small Molecules and Hosts. This includes the ability to customize interaction information between Parts, Devices, Circuits, Small Molecules and Hosts. This includes for example, but is not limited to, interactions between DNA binding factors and target DNA sequences; interactions between cellular pools of biomolecules such as DNA polymerases and Ribosome complexes and target Parts, Devices and Circuits; interactions between Parts, Devices and Circuits with Part, Device, Circuit or cellular targets. Such interaction information can be used in manual, semi-automated or automated design or refactoring workflows to ensure assemblies are being constructed according to the rules defined by the interactions.

In some embodiments, a computer program of the disclosure provides a means to define or refine the metadata used to classify Parts, Devices, Circuits, Small Molecules, hosts, assays and interactions. Such definitions can take advantage of published ontologies such as Sequence ontology. Such definitions can be customized to support development of custom ontologies through use of standardized names, definitions, relationships between custom ontology terms. Such definitions can be used to support manual, semi-automated and automated design or refactoring workflows to ensure assemblies are being constructed according to the rules defined by the interactions.

In some embodiments, a computer program of the disclosure provides a means of connecting to external databases to search, retrieve and store locally or remotely information on naturally occurring or designed or refactored biomolecules. The computer program provides a means of managing user access to external database or server accounts. The computer program provides a means of exchanging data in public and proprietary data formats. The computer provides a means of exchanging data securely with external databases.

In some embodiments, a computer program of the disclosure provides a means of connecting to external computational tools and services to search, retrieve and store locally or remotely information derived from computational analysis or processing of naturally occurring or designed or refactored biomolecules. The computer program provides a means of managing user access to external tool or server accounts. The computer program provides a means of exchanging data in public and proprietary data formats. The computer provides a means of exchanging data securely with external tools and services.

In some embodiments, a computer program of the disclosure provides a means of storing information about physical artifacts associated with naturally occurring biomolecules, parts, devices, circuits, hosts, and small molecules. This includes associating a given instance with information about physical locations, quantities, costs, providers, availability and other information that a user might need or wish to associate to a computer record.

In some embodiments, a computer program of the disclosure provides a means to associate a part, design or circuit with a template which has the functional properties associated with a desired design or refactored element but which does not have an associated DNA sequence. Parts, Devices and Circuits with desired properties can be built using the template. The software can use the desired functional characteristics of the template to identify instances of parts, devices and Circuits with an associated DNA sequence. Where more than one possible instance exists the software of the disclosure can design a variant encompassing all the possible design or refactoring choices. Such variant collections can be associated with the original design or refactoring template.

As discussed above, the present disclosure provides a BioCAD software program tool that can provide integrated support for a variety of computer-implemented biomolecular design/refactoring and biological experiment designing methods. In some embodiments, an integrated BioCAD computer program of the disclosure can comprise multiple individual BioCAD software modules, each able to function independently and also able to function simultaneously or in parallel as needed to perform integrated functions as needed by an end user. Sections above and below describe different individual software tools which can function and be used either independently (for e.g., installed independently on a computer) or can be packaged together as an integrated solution (e.g., be installed as an integrated solution to various biological experiment designing issues). Accordingly, although some embodiments below are described as individual tools or computer implemented methods to perform one method, one of skill in the art will recognize that they can be a part of an integrated bio-solutions tool as well.

Systems, software, tools and/or computer program products of the disclosure can be used to design and perform a biological method in silico. Embodiments also relate to execution of the in silico methods to generate an in silico product such as one or more biomolecules, biochemical molecules, or commercial biological products, or a biotechnology product. In silico workflows of the disclosure are useful in designing the best possible method by refining different parameters and steps used in a method in silico prior to performing a wet laboratory experiment, thereby trouble shooting and eliminating numerous production, efficiency and design issues in silico prior to investing in a full scale wet-lab and/or commercial method.

Non limiting examples of biomolecule design methods, biological experiments and/or biological workflows include cloning methods, recombination methods, ligation methods, vector designing methods, methods for synthesis of a nucleic acid, primer design methods, methods for synthesis of a polypeptide, methods for analysis of a cloned molecule, methods of protein analysis, methods for making a modified host. These exemplary methods and workflows are provided for example only and are not intended to limit the present disclosure.

An in silico biological workflow method can comprise a pipeline of instructions comprising a plurality of individual methods, each individual method generating at least one biomolecule that may be used in the next method to produce another biomolecule, wherein steps of each of the plurality of methods comprise a set of computer readable instructions that are listed in sequential order one following the other; and instructions for executing the pipeline of the workflow. In a non-limiting example an in silico workflow for making a modified host system in silico can comprise combining a method for cloning; a method for making a vector; a method for transfecting the vector into a host/modified host; and a method for selection to check the host systems ability to express a gene of interest expressed by the vector.

Non-limiting exemplary biomolecules or commercial biological products that can be produced using one or more computer program products of the disclosure comprise but not limited to clone collections; individual clones; vectors; hosts/modified hosts (for example having modified/designed vectors) to make certain biomolecules and/or biological products or have certain biological properties; polypeptides, such as enzymes, antibodies, hormones; nucleic acids such as various types of RNA, DNA, primers, probes; libraries (e.g., cDNA libraries, genomic libraries, etc.); buffers, growth media, purification systems, cell lines, chemical compounds, fluorescent labels, functional assays, and variety of kits including DNA and protein purification, amplification and modification. These exemplary biomolecules, chemical molecules, and/or commercial products are provided for example only and are not intended to limit the present disclosure.

Those skilled in the art, in light of this disclosure, will recognize that the operations of one or more embodiments of this disclosure may be implemented using hardware, software, firmware, or combinations thereof, as appropriate. For example, some processes can be carried out using processors or other digital circuitry under the control of software, firmware, or hard-wired logic. The term “logic” herein refers to fixed hardware, programmable logic and/or an appropriate combination thereof, as would be recognized by one skilled in the art to carry out a recited function(s). Software and firmware can be stored on computer-readable media. Some other processes can be implemented using analog circuitry, as is well known to one of ordinary skill in the art. Additionally, memory or other storage, as well as communication components, may be employed in embodiments of the disclosure.

FIG. 1 illustrates an example of a computing system and client/server environments, database servers, and networks and their interconnections. FIG. 1 provides an exemplary client/server system 100 showing the general architecture for understanding the interaction and connectivity of a BioCAD tool(s) 114 and computer-implemented methods provided herein. The general architecture includes server 102 and server functions, including tools 114 instructions for design of biomolecules, instructions for designing biological experiments and/or workflows and other scripts which are run on a server computer 102 and that can access a plurality of databases on the server (104, 106, 108 and 109), and web pages 110 that are delivered to client 110. Server computer 102 may be connected to the internet via an internet service provider (ISP). Similarly, client computers 110 may be connected to the internet via an ISP connection. Client/server system 100 may include a user list database 104 for storing users of the system. In some embodiments, users may need to login to the system to access information. Client/server system 100 may also include user data database 106 that may include data stored associated with the plurality of users of the system. For example, a customized method designed by a user may be stored in the user data database 106 as a file. Further, client/server system 100 may include a company database 108 and/or a public access database or a commercial database 109 including databases stored on a cloud (such as GenBank that a user may use to obtain data from) that may include product information that a user may use to produce a biomolecule, chemical, and/or commercial product such as a biotechnology product. A company may update available products periodically to remove products that may not be available anymore or add new products. Furthermore, other tools or software may be uploaded to company database 108 to be downloaded or provided to users. Typically, the server computer is maintained by a provider of biological products and of the biological computer products (BioCAD tools and software) provided herein, and the client computer is a computer of a customer who purchases a BioCAD tool or software of the disclosure. However, a BioCAD tool of the disclosure can be situated on a client computer or accessed remotely from a server. In various embodiments, there is a plurality of client computers 110 in communication with server 102. Client computers 110 may display user interfaces such as webpages 110 and/or biomolecule viewers 112 according to various embodiments described herein. A molecular viewer can often have several panes for viewing a biomolecule in different ways—e.g., biological sequence view, 3-D view, DNA sequence view, protein sequence view, vector view etc. and a customer/user can generally change the view as desired.

In some embodiments, server 102 or another server in communication with client computers may store user data such that a user may download data, including user generated and/or default design methods or workflows, from the server. Furthermore, a user may store data that may be accessed by other users of the client/server system 100. For example, according to some embodiments described herein, a method to design a biomolecule or a method to conduct a biological workflow or a biological experiment may be shared with another user or a group of users.

As mentioned above, according to various embodiments, user data may be stored in the user data database 106. User data may include user feedback on a method designed by the same or another user or on a biomolecule and/or biological product that results from carrying out a method of the disclosure. In various embodiments, user data may be further analyzed to generate personalized recommendations for a user, such as commonly used parameters by the user or offer recommendations of commercial products that a user may want to purchase to conduct an experiment designed using a software BioCAD tool.

In another aspect of the disclosure, a documented Application Programming Interface (API) is provided to a customer that is associated with an in silico design method, an in silico workflow method, and/or a computer program product. API further can provide product ordering options to a customer such that a customer can route orders through that customer's computer system, such as a business-to-business system.

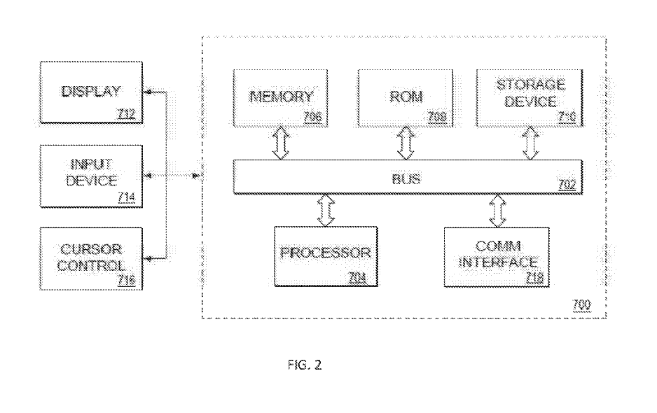

FIG. 2 is a block diagram that illustrates a computer system 700 that may be employed to carry out processing functionality, according to various embodiments. Computing system 700 can include one or more processors, such as a processor 704. Processor 704 can be implemented using a general or special purpose processing engine such as, for example, a microprocessor, controller or other control logic. In this example, processor 704 is connected to a bus 702 or other communication medium.

Further, it should be appreciated that a computing system 700 of FIG. 2 may be embodied in any of a number of forms, such as a rack-mounted computer, mainframe, supercomputer, server, client, a desktop computer, a laptop computer, a tablet computer, hand-held computing device (e.g., PDA, cell phone, smart phone, palmtop, etc.), cluster grid, netbook, embedded systems, or any other type of special or general purpose computing device as may be desirable or appropriate for a given application or environment. Additionally, a computing system 700 can include a conventional network system including a client/server environment and one or more database servers, or integration with LIS/LIMS infrastructure. A number of conventional network systems, including a local area network (LAN) or a wide area network (WAN), and including wireless and/or wired components, are known in the art. Additionally, client/server environments, database servers, and networks as illustrated in the example in MG. 1 are well documented in the art.

Computing system 700 may include bus 702 or other communication mechanism for communicating information, and processor 704 coupled with bus 702 for processing information.

Computing system 700 also includes a memory 706, which can be a random access memory (RAM) or other dynamic memory, coupled to bus 702 for storing instructions to be executed by processor 704. Memory 706 also may be used for storing temporary variables or other intermediate information during execution of instructions to be executed by processor 704. Computing system 700 further includes a read only memory (ROM) 708 or other static storage device coupled to bus 702 for storing static information and instructions for processor 704.

Computing system 700 may also include a storage device 710, such as a magnetic disk, optical disk, or solid state drive (SSD) is provided and coupled to bus 702 for storing information and instructions. Storage device 710 may include a media drive and a removable storage interface. A media drive may include a drive or other mechanism to support fixed or removable storage media, such as a hard disk drive, a floppy disk drive, a magnetic tape drive, an optical disk drive, a CD or DVD drive (R or RW), flash drive, or other removable or fixed media drive. As these examples illustrate, the storage media may include a computer-readable storage medium having stored therein particular computer software, instructions, or data.

In alternative embodiments, storage device 710 may include other similar instrumentalities for allowing computer programs or other instructions or data to be loaded into computing system 700. Such instrumentalities may include, for example, a removable storage unit and an interface, such as a program cartridge and cartridge interface, a removable memory (for example, a flash memory or other removable memory module) and memory slot, and other removable storage units and interfaces that allow software and data to be transferred from the storage device 710 to computing system 700.

Computing system 700 can also include a communications interface 718. Communications interface 718 can be used to allow software and data to be transferred between computing system 700 and external devices. Examples of communications interface 718 can include a modem, a network interface (such as an Ethernet or other NIC card), a communications port (such as for example, a USB port, a RS-232C serial port), a PCMCIA slot and card, Bluetooth, etc. Software and data transferred via communications interface 718 are in the form of signals which can be electronic, electromagnetic, optical or other signals capable of being received by communications interface 718. These signals may be transmitted and received by communications interface 718 via a channel such as a wireless medium, wire or cable, fiber optics, or other communications medium. Some examples of a channel include a phone line, a cellular phone link, an RF link, a network interface, a local or wide area network, and other communications channels.

Computing system 700 may be coupled via bus 702 to a display 712, such as a cathode ray tube (CRT) or liquid crystal display (LCD), for displaying information to a computer user. An input device 714, including alphanumeric and other keys, is coupled to bus 702 for communicating information and command selections to processor 704, for example. An input device may also be a display, such as an LCD display, configured with touchscreen input capabilities. Another type of user input device is cursor control 716, such as a mouse, a trackball or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane. A computing system 700 provides data processing and provides a level of confidence for such data. Consistent with certain implementations of embodiments of the present teachings, data processing and confidence values are provided by computing system 700 in response to processor 704 executing one or more sequences of one or more instructions contained in memory 706. Such instructions may be read into memory 706 from another computer-readable medium, such as storage device 710. Execution of the sequences of instructions contained in memory 706 causes processor 704 to perform the process states described herein. Alternatively hard-wired circuitry may be used in place of or in combination with software instructions to implement embodiments of the present teachings. Thus implementations of embodiments of the present teachings are not limited to any specific combination of hardware circuitry and software.

The term “computer-readable medium” and “computer program product” as used herein generally refers to any media that is involved in providing one or more sequences or one or more instructions to processor 704 for execution. Such instructions, generally referred to as “computer program code” (which may be grouped in the form of computer programs or other groupings), when executed, enable the computing system 700 to perform features or functions of embodiments of the present disclosure. These and other forms of computer-readable media may take many forms, including but not limited to, non-volatile media, volatile media, and transmission media. Non-volatile media includes, for example, solid state, optical or magnetic disks, such as storage device 710. Volatile media includes dynamic memory, such as memory 706. Transmission media includes coaxial cables, copper wire, and fiber optics, including the wires that comprise bus 702.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 704 for execution. For example, the instructions may initially be carried on magnetic disk of a remote computer. The remote computer can load the instructions into its dynamic memory and send the instructions over a telephone line using a modem. In some embodiments a modem local to computing system 700 can receive the data on the telephone line and use an infra-red transmitter to convert the data to an infra-red signal. An infra-red detector coupled to bus 702 can receive the data carried in the infra-red signal and place the data on bus 702. Bus 702 carries the data to memory 706, from which processor 704 retrieves and executes the instructions. The instructions received by memory 706 may optionally be stored on storage device 710 either before or after execution by processor 704. In some embodiments wireless internet connectivity can be used to access and receive data from by remote computer.

It will be appreciated that, for clarity purposes, the above description has described embodiments of the disclosure with reference to different functional units and processors. However, it will be apparent that any suitable distribution of functionality between different functional units, processors or domains may be used without detracting from various embodiments of this disclosure. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

In some embodiments of the present disclosure, in silico methods are described that can be performed (executed), by a user, to obtain a biomolecule a biomolecular aggregate and/or a biotechnology product comprising one or more steps that may be accessible and controllable by the user via a Graphical User Interface (GUI) that is visible on Display 712. A user may enter data (e.g. external data) and/or select options provided in the GUI using Input Device 714 and/or Cursor Control 716. In some embodiments, components of computer system 700 convert input data provided by a user into a computer readable format to one or more computer system components (such as a memory, a database, a processor etc.) to enable interpretation of input data received from a user and to initiate controller instructions to conduct one or more steps of the in silico method.

In some embodiments, user input data may also be used for report generation of the particular in silico method being performed. In some embodiments, components of computer system 700, such as Display 712, may also receive data from one or more processors/sensors/detectors following performing one or more steps of an in silico method that are then converted into a user understood format to enable a user to monitor progress of the workflow steps and/or to obtain additional input from a user to determine the next course/step of the workflow in the in silico method. Input of data from a user or translation of data received from various devices within computer system 700 may be mediated by components of a software (or computer program) of the disclosure which comprises a computer readable medium comprising computer readable instructions, which, when executed by the computer system, are configured to display on Display 712 (screen, LCD).

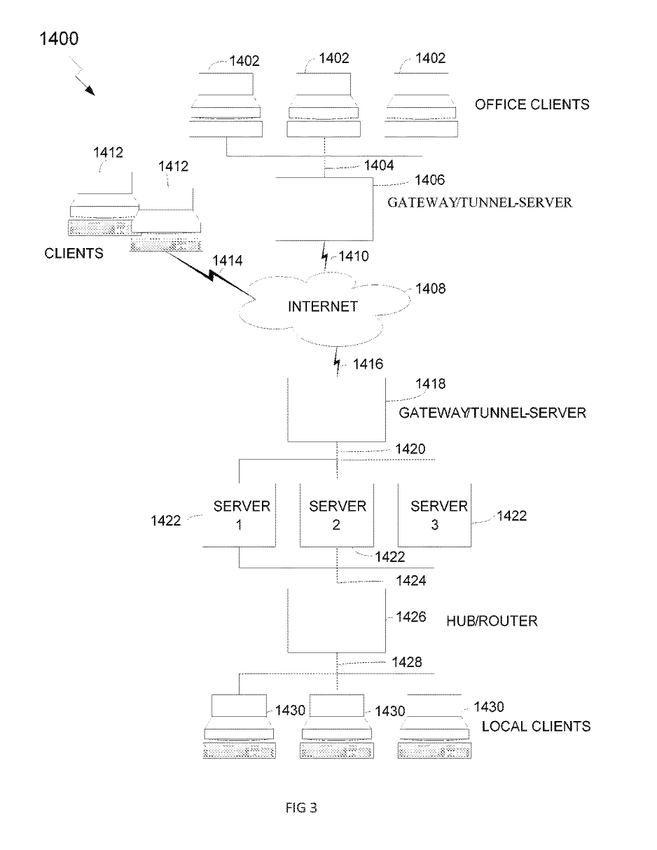

FIG. 3 is a block diagram that illustrates a typical Internet network configuration wherein a number of client machines 1402 possibly in a remote local office, are shown connected to a gateway/hub/tunnel-server/etc. 1410 which is itself connected to the internet 1408 via some internet service provider (ISP) connection 1410. Also shown are other possible clients 1412 similarly connected to the internet 1408 via an ISP connection 1414, with these units communicating to possibly a central lab or office, for example, via an ISP connection 1416 to a gateway/tunnel-server 1418 which is connected 1420 to various enterprise application servers 1422 which could be connected through another hub/router 1426 to various local clients 1430. Any of these servers 1422 could function as a development server for the analysis of potential content management and delivery design solutions as described in the present invention, as more fully described below.

A software (or computer program or a computer tool) of the disclosure may be operable to receive user instructions, either in the form of user input into a set parameter fields, e.g., in a GUI, or in the form of pre-programmed instructions such as but not limited to pre-programmed instructions for performing a variety of different specific operations and/or for analyzing various parameters and/or for analyzing one or more data components. A software (a BioCAD tool, integrated BioCAD solution tool) of the disclosure, in some embodiments, may be operable to convert pre-programmed instructions to appropriate computer language for instructing operation of system 700 to carry out a desired operation. A software of the disclosure, in some embodiments, may be operable to convert data signals or parameters received into appropriate computer language that may then be analyzed by a processor in computer and/or converted into user viewable format for a user to review or analyze.

In some embodiments, a software of the disclosure may comprise functional specifications as well as graphical user interface (GUI) specifications. GUI specifications enable user mediated methods. Exemplary GUI's of the present disclosure may comprise some general GUI specifications. In some embodiments, general GUI specifications may comprise all screens, with the exception of pop-up screens, being 800 pixels wide and 480 pixels high.

Other general GUI specifications may include without limitation, the availability of a Home button in all menu screens where Home button allows a user to navigate to a Main Menu; the availability of Breadcrumbs or a Breadcrumb Trail in all menu screens (breadcrumbs may be abbreviated when they are too long for display); the availability of Time and Date in all menu screens; the availability of a Back button in all menu screens where a Back button allows a user to navigate to a previous screen; the availability of a Save button in screens where a user can change and save one or more fields. Breadcrumbs refer to a navigation aid used in a user interface to show the path that a user has taken to arrive at a screen.

In some embodiments, in a GUI where a Save button is available, a Back button may allow a user to either save or cancel a change, if any, before navigating to previous screen. In some embodiments, in a screen where a Save button is available, a Home button allows a user to either save or cancel a change, if any, before navigating to a Home screen. General GUI specifications also include the availability of a Keypad in user interfaces where a user needs to enter an alpha-numeric string or special character keys. Some examples of GUIs of the disclosure are described later in this application.

Exemplary software and/or computer program products of the disclosure can be used to perform in silico design of a method to produce one or more biomolecules, chemical molecules, or biotechnology products (design of a biological workflow). In silico designing to make or produce one or more biomolecules, chemical molecules, or biotechnology products using one or more computer program products of the disclosure can include production of biomolecules, chemical molecules, or biotechnology products such as but not limited to clone collections and individual clones; vectors; hosts/modified hosts (for example having modified/designed vectors) to make certain biomolecules, chemical molecules, or biotechnology products or have certain biological properties; polypeptides, such as enzymes, antibodies, hormones; nucleic acids such as various types of RNA, DNA, primers, probes; libraries (e.g., cDNA libraries, genomic libraries, etc.); buffers, growth media, purification systems, cell lines, chemical compounds, fluorescent labels, functional assays, and variety of kits including DNA and protein purification, amplification and modification. Further, these exemplary products are provided for example only and are not intended to limit the present disclosure.

One or more methods of the disclosure can be performed in silico using a computer system comprising a non-transitory computer readable storage medium encoded with instructions, comprising computer readable instructions (such as a computer program), which, are executable by a processor of the computer system. A biological computer aided design (BioCAD) tool of the disclosure can be implemented by execution by a processor of instructions encoded onto a non-transitory computer-readable storage medium.

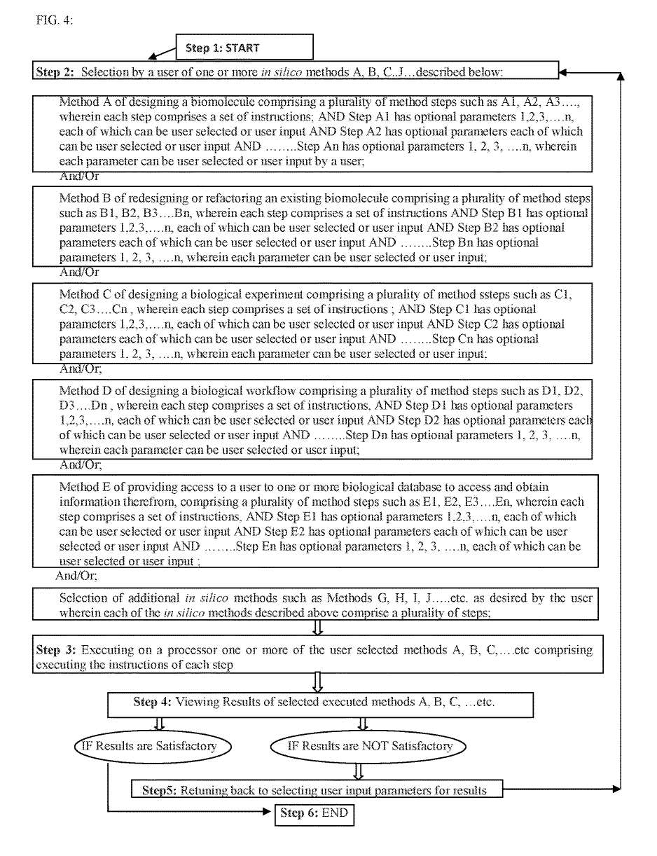

FIG. 4 depicts an example in silico method 900 according to the present embodiments comprising steps 1-6. At step 1, a user can start a method by for example logging on to the appropriate software and entering all user and initial information. At step 2 a user can begin by selecting one or more in silico methods for performing one or more biological experiments/workflows/molecular designing: for this a user can select from a preexisting method or create independently (using code on the tool) a method comprising a series of steps, e.g., method A comprising a series of steps A1, A2, A3, . . . An. Each method step (A1, A2, A3...) would comprise instructions or a set of instructions encoded onto a non-transitory computer-readable storage medium that are executable by a processor. Each method step A1, A2, A3 . . . An will have different variable parameters associated with it. Variable parameters can be user selected or user input. Accordingly a user can independently from his/her knowledge or from other sources input a value for each parameter (such as temperature, pH, selection of a part, a device or circuit, arrangement of parts in a device or circuit, selection of reagents etc.). A user can also selecte parameters from default parameters already provided in the software using a drop down box or similar selection device. A user can also vary steps of each method by adding, removing, modifying and/or changing sequence of steps. A user can select any number of methods he/she wishes to perform and select or input parameters and steps for each method A, B, C . . . that he/she chooses to select. A user has the option of returning to any step of any method and re-inputting a parameter or changing a step.

In Step 3 a user can execute the selected method or methods by selecting appropriate “Run” type of button on a GUI screen which causes the processor to execute the set of instructions comprising a method. Results can then be viewed in Step 4. Typically, results can be viewed on a screen. In the case of designing a new biomolecule or refactoring an existing bimolecule, a molecule viewer screen would be available to view the resulting molecule. In some embodiments, users may also be able to view intermediates.

If a user is NOT satisfied with the results of a method, he/she can go back in step 5 to step 2 of selecting method, selecting parameters and re-select and/or input different parameters to refine the method. If a user is satisfies with the outcome they have the option of ending the program and saving the method that was satisfactory. Iterative ability is provided.

In some embodiments, instructions of a computer readable storage medium of the disclosure may comprise instructions to display on a display screen series of steps that can be performed to obtain a biotechnology product or a biomolecule. In some embodiments, the displayed series of steps are displayed on a GUI navigation panel (or display pane) where selecting a step highlights that and takes a user to another navigation panel or GUI screen (or display pane) which provides a list of parameters that may be inputted by a user to make the biomolecule or biotechnology product. Accordingly, in some embodiments, instructions of a computer readable storage medium of the disclosure may comprise instructions to display on a display screen (such as a second display screen or a second display pane), steps comprising one or more parameters that can be selected by a user using a GUI button in a first display screen or display pane.

Using a GUI, a user can customize one or more of these steps by providing user inputs for the parameters. In some embodiments, user inputs may comprise customized inputs that may be user designed (generated by a user, imported by a user or modified from default parameters by a user). In some embodiments, user inputs may be selected from a set of default parameter inputs that are comprised/stored in the computer program (for example a database having default alternative parameters/values that may be available for the user to select (for example, in the form of a drop down menu)).

In silico designed methods of the disclosure, in some embodiments, comprise a user navigating through steps in a sequential fashion (navigation in ordered steps) or in no particular sequence and may be able to navigate back and forth to input parameter data into various steps out of order (navigation in random steps) prior to performing (executing) the entire user designed method.

In some embodiments, a computer-readable storage medium encoded with instructions, executable by a processor, comprises instructions for: 1) executing user designed methods comprising a plurality of steps; and 2) instructions for viewing products and/or intermediate products obtained by one or more of the steps of the user defined method thereby allowing a user to view an intermediate product or a final product and determine if the method step(s) need to be modified additionally to arrive at a desired final product.

Accordingly, the present disclosure provides a user with a tool to review progress of steps of a biotechnology method or experiment by viewing biotechnology products and providing the ability to change one or more conditions, parameters and/or criteria associated with that step by inputting/selecting another parameter and/or criteria if either an intermediate biotechnology product or a final biotechnology product was not found to be satisfactory or optimum, thereby allowing the user to design a better method for making the final biotechnology product. In some embodiments, a user may be able to determine what parameters to input into a method based on ability to review in silico the outcome of the method (intermediate product and/or final product).

In some embodiments of the disclosure, a computer-readable storage medium encoded with instructions, executable by a processor, can comprise instructions for: storing each user selected/input parameter associated with each step/sub-step of a biotech method in a memory and instructions for allowing a user to retrieve the stored parameters. Accordingly a user may store and retrieve a log of one or more user-defined method (user defined workflow) comprising information that was input/selected by a user, in the form of a electronic lab note book, thereby accurately capturing all changes made/all parameters input by user in a method. This allows for accurate reproduction and tracking of changes made to an user designed experiment or workflow for obtaining a biotechnology product. In some embodiments, a user-defined method that is stored may be then converted into user viewable format for display, and/or copying and/or sending to the same or different user in various human readable formats (email, html etc). In some embodiments, optimized methods designed by the in silico methods described herein can be shared by a plurality of users.

Methods of the disclosure can further include performing laboratory steps (corresponding to the in silico steps) to confirm and possibly expand the determinations made using the in silico methods to produce a biotechnology product that is optimal (in quality and/or quantity (yield)) and/or arrive at a biotechnology method with optimal efficiency for producing a biotech product.

In some embodiments, a biotechnology process of the disclosure, may be a computational biology process(es). Biotechnology processes and their analysis is often carried out in multistep processes that can be generalized steps, customized steps and/or a combination of generalized and customized steps.

Some embodiments of the present disclosure provide an integrated bioinformatics solution for BioCAD that enables a user or a plurality of users to perform one or more of the following methods, including but not limited to: in silico collection and management of biological data; in silico analysis of biological data with software tools (e.g., to discover new information from a set of biological data); and/or ability to design new biomolecules in silico; and/or ability to redesign or refactor an existing biomolecule(s) in silico; and/or in silico ability to design and simulate performance of experimental tools, and/or in silico ability to design and simulate performance of reagents and/or of designed biomolecules (e.g., such as clones, vectors, proteins, chimeras, etc., designed and/or derived from a user created/obtained data);and/or both in silico and in vitro ability to confirm, verify and/or validate the performance of user designed experimental systems and/or workflows; and the ability to order and receive (i.e., purchase online and receive) reagents, biomolecules and other experimental supplies based on in silico design for performing in vitro or in vivo experiments; and/or the ability to reuse existing CAD tools, experimental tools, biomolecules (e.g. clones) and/or reagents.

Each of the in silico methods described above comprise a plurality of steps; and the software of the providing a user ability to navigate to any step of an in silico method as described above; providing a user the ability to view, set, or change one or more parameters associated with each step; and providing a user the ability to view the designed biomolecule and/or an intermediate designed biomolecule and/or the results and/or intermediate results of the designed biological experiment and/or the designed biological workflow to decide if the designed biomolecule and/or the designed experiment and/or the designed workflow is satisfactory; and providing the user ability at any step to go back to any previous steps to modify parameters if the design is not satisfactory (i.e., providing a user iterative design capability).

One or more parameters that can be viewed, selected, set or changed by a user can comprise default parameters, which are pre-determined parameters stored in the computer-readable storage medium, and/or user input parameter, which are either modified default parameters, parameters input by user, and/or a parameter imported by the user into the computer system. In some embodiments one or more parameters viewed, selected, set or changed by a user comprise a combination of one or more default parameters and one or more user defined parameters.

A BioCAD tool of the disclosure also provides a user ability to navigate to any step of an in silico method comprising a plurality of steps and navigation can be by a graphical user interface (GUI) which can comprise displaying on a first display screen pane all the subroutines of a sequential subroutine comprising the biological workflow and, following selection by the user of any one subroutine, displaying on a second display screen, one or more steps associated with the selected subroutine. Providing the user the ability to navigate to any step of a subroutine can also be accomplished by a graphical user interface (GUI) which comprises displaying on a first display screen pane a subroutine and displaying on a second display screen, one or more steps associated with the selected subroutine.

In some embodiments, a BioCAD tool of the disclosure comprises a plug-in architecture for database, tools and viewers; and/or a reusable architecture enabling development of solutions for desktop, server and cloud based solutions and/or a defined application programming interface to enable easy access to and reuse of the code base for new application development. In some embodiments, a BIOCAD tool of the disclosure comprises a defined application programming interface to enable easy access to and reuse of code base for new application development. “Code base” is defined as “a computer program or software comprising a set of instructions encoded on a non-transitory computer-readable storage medium executable by a processor.” In some embodiments a BioCAD tool can have a mixture of assessment and feedback loops, permitting a user to easily iterate over different aspects of a design method, experiment or workflow.

Bioinformatic solutions and BioCAD tools of the present disclosure are designed to operate in a wide range of computational environments such as but not limited to a desktop, a platform, a server based environment and/or a cloud based solution, a Macintosh, a Windows and/or a Linux based solution, a 32 bit chip, and/or a 64 bit chip and/or a 128 bit chip based support.

In some embodiments, BioCAD software tools of the disclosure are modular in design thereby permitting a user (such as a computer engineer, a bioinformaticist, or other scientist) to easily develop additional tools based on reusing the base code, permitting a user to add or modify data models used by the software and providing a range of different viewing modules (also referred to as viewers) to visualize data in different formats. In some embodiments, BioCAD software tools of the present disclosure are modular in operation, thereby allowing users to abstract their view of biological data as they move from biological knowledge through the various stages of in silico synthetic biology design (using a method/tool of the present disclosure) and to final implementation in the wet lab. In some embodiments, a BioCAD software tool of the present disclosure supports collaborations between a plurality of users (e.g., different scientists) each user working on different aspects of a project by permitting easy and standardized exchange of data between users, ability to store a project (project comprising a method using a BioCAD tool of the disclosure) with a unique identifier name, access and viewing capability (of the project/data generated from project/intermediates/designed experiments/biomolecules) from a variety of computers/platforms/servers, and ease of publication of reports and designs to be shared within a project or with a user community (such as a scientific community).

The present disclosure relates to the field of synthetic biology which is an engineering approach to traditional molecular biology. Using the BioCAD tools and in silico design methods described herein a user can design and experiment with different parameters and apply their personal knowledge as well as feedback obtained from the BioCAD tool (such as raw data/analyzed data) back into the design process to refine a method to design a biomolecule and/or a method comprising a biological experiment or biological workflow.

Accordingly in some embodiments, the present disclosure provides synthetic biology methods comprising steps of: development of an optimal method for designing a biomolecule and/or an optimal method for performing an biological experimental method and/or a biological workflow, the optimal method in either case comprising a plurality of optimal steps that are arrived at by using a BioCAD tool of the disclosure to initially perform a series of preliminary design method steps and/or a series of preliminary experimental method/biological workflow steps; varying one or more parameters of one or more of the preliminary steps and/or varying one or more of the preliminary steps (sequence of steps, components of steps); reviewing in silico the preliminary designed biomolecule and/or results of an experimental method or workflow; and repeating this process of refining individual steps and reviewing the results in silico till an optimal designed molecule and/or experimental method is arrived at; and arriving at the optimal method steps.

A BioCAD tool of the present disclosure can be an integrated tool capable of performing at least one or more biological experiments and can comprise individual BioCAD tool modules each comprising instructions to perform single experiments. In some embodiments a BioCAD tool of the disclosure comprises modules for development of biomolecule designs, development of experimental designs, development of biological workflows, the management of one or more experiments, collection and analysis of data, cataloging information about a biomolecule or a family of biomolecules.

In some embodiments, a non-transitory computer-readable storage medium encoded with instructions, executable by a processor, for implementing a biological computer aided design (BioCAD) according to the presently developed embodiments, comprises instructions for performing one or more of the following exemplary in silico methods:

1. Methods for management biological data: comprising instructions encoded in a non-transitory computer-readable storage medium for one or more of the following: obtaining biological data; cataloging biological data and/or indexing biological data, sorting biological data, graphing biological data and/or analysis of biological data.

2. Methods for specification of requirements and constraints of a design: comprising instructions encoded in a non-transitory computer-readable storage medium for one or more of the following: defining specification of “parts” “devices” and/or “circuits” during designing or refactoring a biomolecules based on what is desired of the biomolecule; defining experimental/design criteria of experimental methods and/or biological workflows.

3. Methods for design of solutions that can satisfy the conditions set by design constraints: comprising instructions encoded in a non-transitory computer-readable storage medium for one or more of the following: designing a biomolecule and/or an biological experiment using defined specifications of “parts” “devices” and/or “circuits” and/or method steps and/or factors/parameters that would be used in the biological method/workflow.

4. Methods for analysis and refinement of existing designs (of biomolecules or experimental methods/workflows) to overcome prior design, composition and/or assembly related problems or issues with the existing design: comprising instructions encoded in a non-transitory computer-readable storage medium for one or more of the following: redesigning a biomolecule and/or redesigning an biological experiment by stepwise and systematically changing one or more original parameters of each step of the previous design and/or experiment to a first set of changed parameters; viewing and/or analyzing the redesigned biomolecule and/or experiment using the first set of changed parameters to see if it has overcome the previous design composition and/or assembly related issues; and if the redesigned biomolecule and/or experiment has not overcome the prior problems repeating the steps of stepwise and systematically changing one or more parameters of each step to have a second set of changed parameters; viewing and/or analyzing the biomolecule and/or experiment redesigned using the second set of parameters to see of it has overcome the previous problems; and repeating these steps of redesigning and viewing using a third, a fourth and so on till nth parameters till the problems with the original design or experiment are resolved or overcome.

5. Methods for collection of biological parts and for development of compositions of designs and design solutions from the parts collections and/or experimental designs using the parts collections and/or reagent development activities using parts collections: comprising instructions encoded in a non-transitory computer-readable storage medium for one or more of the following: instructions to access one or more sources of parts (such as databases with gene/protein sequence information) and instructions to retrieve parts (instructions can comprise instructions to retrieve parts having certain specifications, some non-limiting examples being promoter sequences, restriction enzyme binding sites, etc.); instructions for a design solution (such as making a biomolecule with one or more parts collected; steps of a biological experiment using one or more parts; developing a reagent comprising parts. A reagent can be an oligo or a nucleotide needed to make the DNA or a modified residue (e.g. methylation).

6. Methods for assembly, validation and verification of designed solutions: comprising instructions encoded in a non-transitory computer-readable storage medium for one or more of the following: instructions to design a biomolecule comprising joining together one or more parts, devices or circuits to create a biomolecule or an aggregate of biomolecules; instructions to be able to view and/or analyze the created biomolecule; ability to go back and change parameters of designing the biomolecule and reiteratively viewing and analyzing and repeating change in parameters till an ideal designed bimolecule is formed; instructions for validation and verification of the designed biomolecule.

7. Methods for host assessment of designs and feedback based upon performance and ability to satisfy the specifications of the design: comprising instructions encoded in a non-transitory computer-readable storage medium for one or more of the following: instructions to perform specific in silico tests on a host (e.g., a host cell into which a designed biomolecule (such as a designed vector expressing a certain protein) is transfected into) to test if the designed biomolecule that is now in the host functions as expected and per design specifications.

8. Iterative support of each of the previous stages through use of tools to assess and data to feedback on simulations vs. experimental results : comprising instructions encoded in a non-transitory computer-readable storage medium for one or more of the following: Instructions to iteratively design a biomolecule or a biological experiment or workflow in silico wherein the results of design are tested repeatedly at different stages and the initial design is modified till an modified design is obtained; and instructions to provide to the software results obtained in vitro or in vivo in a lab conducting the same experiment using the modified design; and instructions to analyze both the in silico and lab results and additionally modifying design parameters based on these results to arrive at a final design.

One of skill in the art will recognize that the present disclosure is not limited to the methods and examples described above which are only exemplary illustrations. Other biological methods teachings can be performed using exemplary synthetic biology method taught herein and the present specification encompasses all such methods.

In some embodiments, the present disclosure provides instructions encoded in a non-transitory computer-readable storage medium that permit users to Curate collections of data. In some embodiments this comprises instructions to: Query for and retrieval of data from public databases; Organization of and management of data into a user specific database; and optionally analyzing the data. In some specific exemplary embodiments this can comprise instructions for: Querying and Collection of biological sequence data from a genome (or protein) based data services or collections; Organization of and management of biological sequence data into a user specific database; and Viewing and editing of biological sequence records.

In some embodiments, the present disclosure provides instructions encoded in a non-transitory computer-readable storage medium that permits users to discover new information about their own data. In some embodiments this comprises one or more of: Tools to perform comparative analysis of biological sequences in pubic databases and in individual user databases; Tools to perform comparative analysis of sets of biological sequence records either from local or server based tools; Tools to perform analysis of 3D structure records of biological data; Tools to analyze biological sequences based upon mathematical tools and formulas; Tools to analyze biological sequences based upon identification of biological motifs; and/or Tools to analyze biological sequences based upon heuristics.

In some embodiments, the present disclosure provides instructions encoded in a non-transitory computer-readable storage medium that permit users to design tools, reagents and clones based upon biological data. In some embodiments this comprises one or more of: Tools for in silico cloning that allow a user to combine a plurality of user selected biological sequences into user designed vectors; Tools for in silico design of oligonucleotide primers; Tools for converting DNA and protein sequences into optimized sequences for gene synthesis; and/or Tools for performing mutagenesis in protein and DNA sequences.

In some embodiments, the present disclosure provides instructions encoded in a non-transitory computer-readable storage medium that permit users to simulate and confirm lab based experimental findings against in silico designs, discover and order reagents from commercial vendors and manage reagent collections with in silico designs. In some embodiments this comprises one or more of: Tools for simulating separation of biological molecules on gels; Tools for assembling, confirming and comparing wet lab electrophoresis results with in silico designs; Tools for querying and obtaining data associated with suitable reagents that a user would need for performing experiments; Tools for submitting custom design of reagents for performing experiments to a third party web site; and Tools for submitting reagent designs to a third party web site for purchasing.

In some embodiments, the present disclosure provides instructions encoded in a non-transitory computer-readable storage medium that permit users customize their interaction with the software and to share this with other users. In some embodiments this comprises one or more of: Tools for customizing the behavior of tools under user defined settings; Tools for customizing the use of certain sets of data under defined settings; Tools for customizing the display of data under certain settings; Tools to create, edit and save such settings; Tools to share such settings with other users of the software; Tools to share data with other users that takes advantage of these configuration settings; Tools to enable users to report upon data by generating images, reports, or other deliverables from the program Databases that enable users to share data with each other. In some embodiments sharing data with other users allows users the ability to choose to share their data under different sets of permissions with other users.

In some embodiments, the present disclosure provides instructions encoded in a non-transitory computer-readable storage medium that permits users the ability to design and develop synthetic biology parts, devices and circuits from native or wild type biological sequences. In some embodiments this comprises one or more of: Identifying sequences corresponding to DNAs, RNAs or Proteins containing a functional property of interest; Importing these sequences into a database; Using query and analysis tools to identify similar sequences based upon annotations, sequence comparison, or other methods of classification; Importing these homologous sequences into the database; Optimizing the sequences for expression in novel target organisms (or hosts); Association and measurement of these sequences in identified standardized assays; Identification and redesign of functional properties in the sequences, such as presence of ribosomal biding sites, promoters, terminators, etc., Classifying the sequences with appropriate terms to identify their functional characteristics; Characterizing these sequences through functional assays to identify their performance characteristics; Storage and retrieval of these sequences for later use in development of new of existing Devices and Circuits.

In some embodiments, the present disclosure provides instructions encoded in a non-transitory computer-readable storage medium that permit users refactor, modify and redevelop synthetic biology parts, devices and circuits from native or wild type biological sequences. In some embodiments this comprises one or more of instructions for and steps of: Importing these sequences with associated classification and characterization data into the database; Providing a user with tools to classify and characterize the Parts, Devices and Circuits that are part of the sequence; Identification and redesign of functional properties in the sequences, such as presence of ribosomal biding sites, promoters, terminators, etc.; Assisting a user with tools to modify the sequence with alternative parts and devices; Characterizing the modified sequences through functional assays to identify their new performance characteristics; Storage and retrieval of these refactored sequences for later use in development of new of existing Devices and Circuits.

In some embodiments, the present disclosure provides instructions encoded in a non-transitory computer-readable storage medium that permits users develop Parts from native or wild type biological sequences. In some embodiments this comprises one or more instructions for and steps of: The ability to select wild type sequences and save them as a Part; The ability to classify a Part for its functional properties. In some embodiments, this includes the provision of core information relating to the part's name, sequence and classification of its functional role. In some embodiments this includes description of the part. In some embodiments this includes the identification of reagents or other Parts associated with the implementation, functional modulation, assembly, use or other experimental aspects of Part. In some embodiments this includes the Classification of the Part's intended host. In some embodiments this includes the description of the origin of the Part, whether biological, synthetic or some other origin. In some embodiments this includes the Source of the Part, including institutional and investigator associated data. In some embodiments this includes information on the intellectual property associated with the Part, including data on patent filings using the Part. In some embodiments this includes associating a specific part with alternative replacement parts.

In some embodiments, instructions encoded in a non-transitory computer-readable storage medium permits users develop Parts from native or wild type biological sequences as described in the paragraph immediately above can further comprise one or more instructions for and steps of: The ability to examine a DNA sequence associated with a Part, which can include the ability to investigate aspects of the DNA, RNA and protein sequences associated with the Part and which in some aspects can include the ability to view, examine, edit and save modifications of the DNA sequence; and in some other aspects this includes the ability to analyze the DNA sequence with DNA specific analysis tools; The ability to examine an RNA sequence associated with a Part which includes the ability to investigate aspects of the DNA, RNA and protein sequences associated with the Part which can include the ability to view, examine, edit and save modifications of the RNA sequence and can additionally include the ability to analyze the RNA sequence with RNA specific analysis tools; The ability to examine a protein sequence associated with a Part which includes the ability to investigate aspects of the DNA, RNA and protein sequences associated with the Part and in some aspects also includes the ability to view, examine, edit and save modifications of the protein sequence and can additionally include the ability to analyze the protein sequence with protein specific analysis tools; and The ability to save the Parts as a new Part instance which in some embodiments includes the ability to export and import the Part in a standardized format; and/or includes the ability to change, modify and publish a pictorial representation of the part; and/or includes sharing of the part with other users.

In some embodiments, instructions to implement a BioCAD tool encoded in a non-transitory computer-readable storage medium permits users to characterize Parts with associated data, such as use of Ontology terms. In some embodiments this comprises one or more steps and instructions for: The ability to use a sequence ontology to classify Parts, Devices and Circuits; The ability to add, edit, delete and save ontology terms in order to customize their use for a specific project; The ability to link ontology terms to an associate graphical representation of the term, permitting generation of schematics for Parts, Devices and Circuits; The ability to use parts, Devices and Circuits classified with ontology terms as a means of manually, semi-automatically or automatically generating sets of solutions for synthetic design projects; and/or The ability to use Ontology terms as a means to search, sort, filter, retrieve parts, devices and circuits.

In some embodiments, instructions encoded in a non-transitory computer-readable storage medium permits users characterize Parts with associated experimental data. In some embodiments this comprises one or more of: The ability to associate external data with a part; This includes the ability to associate a part with an external file; This includes the ability to associate a part with an external internet based universal resource indicator; The ability to associate a Part with textual data managed and stored by the program which can include the ability to associate a part with an internal annotation, note or other means of adding remarks, annotations or other human readable information with a Part and can further include the ability to create, edit, save or delete such data with a part in the program; The ability to associate a part with numerical or analytical measurement data managed and stored by the program which includes the ability to associate a part measurement with a defined assay for part measurement which includes the ability to associate a part with an internal numerical, textual, binary or other data derived from the measurement which includes the ability to save measurement data as a qualitative or quantitative measurement, which includes the ability to create, edit, save or delete such data with a Part in the program which includes the ability to save measurement data as a qualitative or quantitative measurement which can include the ability to save the measurement data with associated units which can also includes the ability to search, sort and filter the measurement data which can include the ability to use the measurement data as a way to select Parts based upon measurement characteristics which can include the ability to display Part measurement data in a comparative fashion which can include the ability to share measurement data for a part with other users.

In some embodiments, instructions encoded in a non-transitory computer-readable storage medium which allows a user to utilize data sheets to summarize information about a Part, Device or Circuit. In some embodiments this includes one or more of: The ability to summarize information on a part; The ability to summarize how a Part was assayed; The ability to summarize the results of the part's performance; The ability to summarize the part's performance as compared to other Parts analyzed in the same assay; The ability to create and share such data sheets with other softwares or users; and/orThe ability to use a standardized reporting format to aid with interpretation of data and ability to be used in a computer program.

In some embodiments, instructions encoded in a non-transitory computer-readable storage medium permits user to organize Parts into collections. In some embodiments this includes one or more of: Tools to associate Parts with design templates based upon their classification; Tools to support and mange data on Parts with physical samples; Tools to support identification of specific Parts as preferred starting materials for synthetic designs; Tools to develop and identify collections of Parts to be used within specific design projects; Tools to search for, sort, filter and retrieve individual or specific parts based upon data associated with individual Parts.

In some embodiments, instructions encoded in a non-transitory computer-readable storage medium to enable users to design develop and manage information on collections of Devices. In some embodiments this includes one or more of: Development of Devices from wild type DNA sequences; Import of known characterized DNA devices from third party collections using defined data formats and models; Design of DNA devices through assembly of Parts; Management of classification and characterization data associated with DNA devices which includes information on desired and undesired interactions with other classes of parts or devices in silico or within a target organism; Association of known devices with design templates; Association of devices with physical samples; Identification of devices as preferred starting materials for synthetic designs; Identification of collections of devices to be used within specific design projects; Ability to search for and retrieve individual or specific parts based upon classification, characterization or preferences.

In some embodiments, instructions encoded in a non-transitory computer-readable storage medium to enable users to design develop and manage information on collections of Circuits. In some embodiments this includes one or more of: Development of Circuits from wild type DNA sequences or pathways; Import of known characterized DNA circuits from third party collections using defined data formats and models; Design of DNA circuits through assembly of Parts and Devices; Management of classification and characterization data associated with DNA circuits which includes information on desired and undesired interactions with other classes of parts, devices or circuits in silico or within a target organism; Association of known circuits with design templates; Association of circuits with physical samples; Identification of circuits as preferred starting materials for synthetic designs; Identification of collections of circuits to be used within specific design projects; Ability to search for and retrieve individual or specific circuits based upon classification, characterization or preferences.

In some embodiments, instructions encoded in a non-transitory computer-readable storage medium to enable users to develop circuits based upon defined interactions with external define elements. In some embodiments this includes: Tools to assist with identification of external small molecules that will interact with the Circuit or its component Devices which in some embodiments includes identification of small molecules, in some embodiments these small molecules may be part of a cells metabolome and in some embodiments these small molecules may be part of the environment the cell is growing in; Tools to assist with identification of internal metabolites that will interact with the Circuit or its component Devices which in some embodiments includes identification of metabolites in or generated by the Circuit or its component Devices; Tools to assist with identification of external Proteins that will interact with the Circuit or its component Devices which in some embodiments this includes identification of proteins and in some embodiments these proteins may be part of the cell's proteome while in some embodiments these proteins may be part of the environment the cell is growing in; Tools to assist with identification of internal Proteins that will interact with the Circuit or its component Devices which in some embodiments includes identification of proteins in or generated by the Circuit or its component Devices; Tools to assist with identification of external RNAs that will interact with the Circuit or its component Devices which in some embodiments includes identification of RNAs and these RNAs in some embodiments may be part of the cell's transcriptome or in some embodiments these RNAs may be part of the environment the cell is growing in; Tools to assist with identification of internal RNAs that will interact with the Circuit or its component Devices which in some embodiments includes identification of RNAs in or generated by the Circuit or its component Devices; Tools to assist with identification of external DNAs that will interact with the Circuit or its component Devices which in some embodiments this includes identification of DNAs and in some embodiments these DNAs may be part of the cell's genome while in some embodiments these DNAs may be part of the environment the cell is growing in; Tools to assist with identification of internal DNAs that will interact with the Circuit or its component Devices which in some embodiments this includes identification of DNAs in or generated by the Circuit or its component Devices; and Tools to specify the behavior of the Device or Circuit with interacting molecules. This results in a human readable model of the interaction of the device or circuit with the interacting molecule. In some embodiments this includes the description of the model with a truth table.

In some embodiments, instructions encoded in a non-transitory computer-readable storage medium to enable users to abstract Parts, Devices and Circuits. In some embodiments this includes one or more of instructions and steps for: Creation of a Part, Device or Circuit templates based upon desired Classification and Characterization parameters. This does not include specification of specific instances of Parts, Devices or Circuits. The purpose of having template in designing a device/circuit is to enable the software to generate a list of all possible Part, Device or Circuit designs solutions. In some embodiments this enables users to move from general to specific designs. In some embodiments this enables a user or a tool of the disclosure to move from general to specific design recommendations.

In some embodiments of the present disclosure, templates for parts, Devices and Circuits can be generated using rules. In some embodiments these rules specify conditions needed to satisfy the functionality of the part, Device or Circuit in a target host. In some embodiments the rules specify rules concerning the functioning of the part, Device or Circuit. In some embodiment templates can contain possible combination of parts which are available in the system database.

A tool of the disclosure typically allows a user to access all allowable part, device and Circuit solutions that can be generated for the template. In some embodiments such solutions can be saved as part of a Design or refactoring project for later retrieval. In some embodiment the solutions can be selected for experimental development by creating a solution variant. In some embodiments a BioCAD system can display each solution and/or a plurality of variant solutions for ease of comparison to a part, Device or Circuit template.

In some embodiments, instructions encoded in a non-transitory computer-readable storage medium provides tools to enable users to use calculators as a way to screen for desired functional properties in Parts, Devices or Circuits. In some embodiments this includes one or more of: DNA specific analysis tools to identify and engineer for DNA specific properties, such as restriction enzymes and methylation sites; and/or RNA specific analysis tools to identify and engineer for RNA specific properties such as RNA secondary structure; and/or protein specific analysis tools to identify and engineer for optimized protein expression into identified expression systems based upon codon usage preferences, availability of ribosome binding sites. This includes calculators to perform surveillance upon an input sequence for the presence of desired functional elements or pseudo functional elements. Non-limiting exemplary functional elements that can be identified or analyzed for include calculators to perform surveillance for the presence of ribosome binding sites, the presence of terminators and/or the presence of promoter sites.

In some embodiments, instructions encoded in a non-transitory computer-readable storage medium to enable users to use calculators as a way to design for desired functional properties in Parts, Devices and Circuits. In some embodiments this includes: DNA specific design tools such as promoter design tools to identify orthologous DNA binding proteins or to identify possible non-orthologous interactions with other devices or the host genome; and/or RNA specific analysis tools to identify and engineer for RNA specific properties such as RNA secondary structure; and/or protein specific analysis tools to identify and engineer for optimized protein expression into identified expression systems based upon availability of ribosome binding sites of appropriate strength.

In some embodiments, instructions encoded in a non-transitory computer-readable storage medium to enable users to use graphical design tools to manually manipulate and use parts, Devices and Circuits. In some embodiments this includes: the use of GUI elements to enable to access to parts, Devices and Circuits, to enable dragging and dropping parts, devices and Circuits onto a canvas to support design goals, and access to data and information associated with Parts, Devices and Circuits.

In some embodiments, instructions encoded in a non-transitory computer-readable storage medium to enable users to use rules based assembly of Parts, Devices and Circuits. In some embodiments this includes: The development of compositional rules, wherein users determine and constrain parts, Devices and Circuits based upon associated classification or characterization data. This includes development of positional rules, wherein users determine and constrain selection of parts, devices and Circuits based upon their ordering and appearance in designs. This can also include the identification of constructional rules based upon the physical state of a part, transitioning from a purely in silico design to a tested and validated element with associated physical samples. The rules engine uses compositional, positional and constructional information as a means to query database of parts, devices and Circuits for complimentary qualities and then provide lists of possible variants that fulfill the design rules. The software uses the fit of the component parts, devices and Circuits as a means to calculate a compatibility score indicating the suitability of a given design to the original design rules.

In some embodiments, instructions encoded in a non-transitory computer-readable storage medium to enable users to use calculators compare the compatibility of parts, devices and circuits with a variety of DNA assembly methodologies. In some embodiments this includes: Tools that provide the ability to set up and reuse rules based upon the assembly of DNA sequences using restriction enzyme and ligation based cloning; the use of recombinant approaches to combine DNA sequences, such as gateway cloning, and; the use of homology based cloning methodologies such as Geneart® Seamless Assembly or Gibson assembly. The software provides a means to setting up the initial conditions to perform cloning for each type of assembly method. It provides a means of running compatibility checks for each construct in order to identify variants that fit the criteria or conditions for which the assembly would likely fail. It provides the means of correcting these problems. It also provides a means to perform the cloning assembly, create associated reagents and allow users to save such design experiments to the database.

In some embodiments, instructions encoded in a non-transitory computer-readable storage medium to allow users to share, report and order parts, devices and circuits. In some embodiments this includes: Tools and data models to publish designs as images. A BioCAD tool of the disclosure supports the import and export of designs in standard file formats and provides users a means of saving designs to a shared database to publish to other end users. A BioCAD tool of the disclosure, in some embodiments, provides a means of pushing information on Parts, Devices and Circuits to other software through standardized interfaces and provides a means of pushing information related to the creation of reagents for part, device and circuit development to an online ordering system.

A BioCAD tool of the disclosure, in some embodiments, enables user to submit parts, devices and circuits for assembly manually or through semi automated or automated means. In some embodiments this includes: Tools to support the interaction of user developed computer programs with the software through an application programming interface. The present software provides a means of integrating new tools, data types and interfaces through a series of pluggable components. The present software provides a means of printing lists of data concerning parts, devices and circuits in a configurable way to allow use of this data in manual, semi-automated or automated assembly systems.

A BioCAD computer program of the disclosure, in some embodiments, provides tools to enable users to perform manual, semi-automated and automated design of Devices and Circuits. In some embodiments this includes: Inclusion of an assembly engine to automate search and validation of Parts and Devices for Device and Circuit design; and/or Inclusion of broad categories of rules that can be used for selection of parts, Devices and Circuits. Rules, in some embodiments comprise compositional rules which comprise various types of parts, deices and Circuits that can be considered for design and/or positional rules comprising various ways in which Parts, Devices and Circuits can be combined together; and/or Provision of a design canvas to represent the components being used in the design at a part, device and Circuit level of representation; Provision of levels of abstractions for parts, Devices and Circuits as part of the design. In some embodiments this includes use of templates and generic representations of parts, Devices and Circuits with certain Classification and Characterization parameters but which are not linked to a physical instance of such elements.

In some embodiments, an assembly engine uses classification and characterization data for identification of suitable Parts, Devices and Circuits as part of designed solution. In some embodiments this includes ontology and/or other classification data and/or characterization data.

A BioCAD tool of the disclosure, in some embodiments, comprises a provision of a search engine capable of performing validation for use of a collection of Parts for development of a Device or Circuit component via a set of rules. In some embodiments an assembly engine can generate rules dynamically using ontology terms and characterization data from a set of chosen design components. As the user of the BioCAD tool software makes changes to the basic design, the assembly engine will compare user driven changes with assembly rules. In some embodiments this will results in the assembly engine identifying novel designs that can be made. In some embodiments this will result in the assembly engine removing designs due to violations of the assembly rules.

A BioCAD tool of the disclosure, in some embodiments, enables users to identify the most optimal solution for a designed Device or Circuit based upon a scoring mechanism. In some embodiments this includes: An algorithm that evaluates the suitability of an individual Part, device or Circuit as part of the design solution. In some embodiments this includes evaluating the Classification data for how close it is to the original specified design rule. In some embodiment this includes evaluating the Characterization data for how close it is to the original specified design rule. The algorithm calculates a suitability score for each part, device or circuit in the design. The algorithm sums the suitability of each part, device and circuit in the design. The algorithm sums the theoretical maximal score for the original design. The solution score is the ratio of the actual score divide by the theoretical maximal score. In some embodiments this score takes into account suitability of the proposed parts, Devices and Circuits for expression in a target organism (or host cell). In some embodiments the score takes into account the pair wise performance and suitability of parts, devices and Circuits. In some embodiments the algorithm takes into account the qualitative vs quantitative nature of some forms of Characterization measurements.

A BioCAD tool of the disclosure, in some embodiments, enable users to compare methods of assembling parts, Devices and Circuits with target Vectors. In some embodiments this includes: The provision of a tool to perform comparative automated assembly of Parts into devices and Devices into Circuits. In some embodiments this includes the ability to have an interactive, visual way to compare assembly technologies for suitability and for anticipated experimental issues. In some embodiments this includes the ability to select between different assembly modalities, such as restriction enzyme based, recombination site based or homologous recombination based assembly approaches. In some embodiments this includes the ability to iteratively make changes to Device and Circuit designs and re-validate the designs for compatibility with the planned experimental assembly approach.

The present disclosure, in some embodiments, provides a BioCAD tool to assist users to validate an assembly strategy with one or more identified assembly approaches. In some embodiments a tool of the disclosure can identify parts, Device and/or Circuit combinations that are non-compliant with a certain cloning technologies. In some embodiments the tool identifies the issues that will prevent these parts, devices and Circuits from being assembled with the selected assembly approach. In some embodiments the tools facilitates a user by repetitive use of the tool for re-validation, re-designing of the compliance of component parts, devices and Circuits until the working design passes or the user chooses an alternative approach.

A BioCAD tool of the disclosure, in some embodiments, provides a parallel, high throughput process of checking assembly approaches several design alternatives and associate the results/metrics (e.g. cost, effort estimates) back to each design variant within their design environment. In some embodiments this checks and validates the viability of their design for the component Parts, Devices and Circuits. In some embodiments this permits users to easily compare designs against one another. In some embodiments this permits users to compare costs associated with several approaches against each other. In some embodiments this permits users to compare the experimental equipment, tools, reagents or other experimental tools needed for each assembly tool.

A BioCAD tool of the disclosure, in some embodiments, provides a way of managing assembly technology parameters/constraints via user preferences. In some embodiments this includes users developing, saving and using their own assembly methodologies. In some embodiments this includes users customizing an existing experimental methodology and saving this for later use. In some embodiments this includes sharing novel or customized experimental assembly methodologies with other users.

In some embodiments, a non-transitory computer-readable storage medium encoded with instructions, executable by a processor as described herein can further comprise: executing a first method for designing a biomolecule and/or a biological experiment or a biological workflow to obtain a product, comprising selecting a first set of parameters for each step and executing in silico all the steps of the in silico method; viewing in silico a first biomolecule or a first product obtained by executing the first in silico method; generation of at least a second method for designing the biomolecule and/or a biological experiment or a biological workflow to obtain the product, comprising selecting a second set of parameters for each step where the second set of parameters each have a different value relative to the same parameter selected in the first method and executing all the steps of the second method in silico; viewing the second biomolecule or second product in silico; and comparing the first biomolecule or first product with the second biomolecule or second product; repeating this for as many “n” iterations as needed; allowing a user to compare the first, second, third...nth product or biomolecule to each other and thereby allowing a user to determine which among the first, second, third....nth set of parameters and produces a preferred biomolecule or preferred product.

Various embodiments of the present disclosure have been described above. It should be understood that these embodiments have been presented by way of example only, and not limitation. It will be understood by those skilled in the relevant art that various changes in form and detail of the embodiments described above may be made without departing from the spirit and scope of the present disclosure as defined in the claims. Thus, the breadth and scope of the present disclosure should not be limited by any of the above-described exemplary embodiments.

1. A computer program for implementing a biological computer aided design (BioCAD) comprising a non-transitory computer-readable storage medium encoded with instructions, executable by a processor, comprising:
at least one data model; and
at least one BioCAD tool;
wherein the at least one BioCAD tool enables a user to design a new designed biomolecule or to refactor an existing or previously designed biomolecule based on the user's input of one or more components of a Part, a Device and/or a Circuit selected by the user from a database that comprises a plurality of components of existing biomolecules;
wherein the at least one data model is operable to manage development of the new designed or refactored biomolecule using one or more databases populated with information on the components of existing biomolecules; and
the computer program comprising instructions to perform an analysis of information on the components of the new designed biomolecule or refactored biomolecule; and
the computer program comprising instructions to provide the user an output comprising information that enables the user to determine in silico if the new designed biomolecule or refactored molecule is satisfactory or if one or more problems are associated with the new designed or refactored biomolecule.

2. The computer program of claim 1, wherein the output further comprises information identifying the source of the one or more problem to in silico selection by the user of one or more components of the Parts, the Devices or the Circuits used to design or refactor the biomolecule.

3. The computer program of claim 2, further comprising instructions to provide the user the ability to resolve the one or more problems by reselecting a different Part, Device and/or Circuit.

4. The computer program of claim 1, wherein the one or more problems comprise:
a) determining if the new designed or refactored biomolecule is compatible with an in vivo environment that it has been designed for;
b) identifying potential errors in silico prior to development work in vivo or in vitro;
c) determining if the new designed or refactored biomoleculs can interact with other molecules as desired;
d) determine if the new designed or refactored biomolecule cannot interact with other molecules as desired; and
e) determine if the new designed or refactored biomolecule has undesired interactions with other molecules, wherein the other molecules are biomolecules, proteins, peptides, antibodies, nucleic acids or small molecules.

5. The computer program of claim 1, having:
instructions to enable a Part to be identified as a Part with an identified functional role and an associated biological, experimental and usage metadata and instructions to include the representation of Parts and Part metadata in the data model;
instructions to enable a Device to be identified as a Device with an identified functional role and an associated biological, experimental and usage metadata and instructions to include the representation of Device and Device metadata in the data model; and
instructions to enable a Circuit to be identified as a Circuit with an identified functional role and an associated biological, experimental and usage metadata and instructions to include the representation of Circuits and Circuit metadata in the data model.

6. The computer program of claim 5, further having:
instructions to enable the definition and use of one or more Small Molecules with identified functional role and associated biological, experimental and usage metadata and instructions to include the representation of Small Molecules and Small Molecule metadata in the data model; and
instructions to enable the defintion and use of interactions between native biomolecules, Small Molecules, Parts, Devices and Circuits with identified functional role and associated biological, experimental and usage metadata and instructions to include the representation of interactions and interaction metadata in the data model.

7. The computer program of claim 5, further having:
instructions to enable the identification of a Host with associated biological properties and associated biological, experimental and usage metadata and instructions to include the representation of the Host and Host metadata in the data model.

8. The computer program of claim 5, further having:
instructions to enable the identification of an Assay with associated experimental properties and results and associated biological, experimental and usage metadata and instructions to include the representation of the Assay and Assay metadata in the data model.

9. The computer program of claim 8, wherein the Assay metadata includes the experimental results derived from measurement of one or more of Parts, Devices, Circuits, Hosts and Small Molecules in the Assay.

10. The computer program of claim 9 further comprising instructions to enable the development, use and management of collections of Small Molecules, Parts, Devices, Circuits, Hosts and Experimental Assay data.

11. The computer program of claim 1, wherein the at least one BioCAD tool enables a user to design a biological experiment and to design a biological workflow relating to the designed biomolecule or refactored biomolecule.

12. A computer program of claim 1, comprising a plurality of data models and BioCAD tools comprising:
a) a data model to manage the development of the new designed or refactored biomolecule the data model based on synthetic biology engineering data;
b) a tool to enable the design of Parts, Devices and Circuits from existing biomolecules;
c) a tool to enable the refactoring of Parts, Devices and circuits from existing biomolecules or previously designed constructs;
d) a tool to scan, design and refactor transcriptional and translational properties of designed or refactored biomolecule;
e) a tools to scan, design and refactor cloning methods that are compatible with a host system chosen for cloning;
f) a tool to identify and resolve potential errors in silico prior to performing development work in vivo or in vitro;
g) a tools and a data model to manage and incorporate experimental data as part of design and refactoring of a biomolecule; and
h) a tool and a data model to manage projects containing both the new designed or refactored biomolecule with their corresponding native biomolecules or systems.

13. The computer program of claim 1, wherein a plurality of icons are used to graphically depict Parts, Devices, Circuits, Small Molecules, Hosts and the interactions between parts, Devices, Circuits, and Small Molecules.

14. The computer program of claim 1, wherein the instructions comprise:
instructions for one or more in silico methods including methods for:
designing a biomolecule;
redesigning or refactoring an existing biomolecule;
designing a biological experiment; and
designing a biological workflow,
wherein each of the in silico methods comprise a plurality of steps, instructions for providing access to a user to one or more biological database to access and obtain
information therefrom, wherein the biological database is situated locally on a desktop, on a server, or in a cloud;
instructions for collecting biological data from the one or more biological database;
instructions for analyzing the collected biological data;
instructions to interact with the one or more data models;
instructions to enable the one or more BioCAD tools;
instructions for providing a user ability to navigate to any step of an in silico method as described above;
instructions for providing a user the ability to view, set, or change one or more parameters associated with each step;
instructions for providing a user the ability to view the designed or refactored biomolecule or an intermediate of a designed or refactored biomolecule or the results or intermediate results of the designed biological experiment or the designed biological workflow to decide if the designed biomolecule or the designed experiment or the designed workflow is satisfactory;
instructions for allowing a user to share the designed or refactored biomolecule or intermediates results with other users and obtain input from the other users; and
instructions for providing the user iterative design capability comprising ability at any step to go back to any previous steps to modify parameters if the design is not satisfactory.

15. A computer-implemented method for designing a new biomolecule or to refactor an existing or previously designed biomolecule or to design a new experiment or a workflow comprising:
using a computer program for implementing a biological computer aided design (BioCAD) comprising a non-transitory computer-readable storage medium encoded with instructions, executable by a processor, comprising:
at least one data model; and
at least one BioCAD tool;
wherein the at least one BioCAD tool enables a user to design a new designed biomolecule or to refactor an existing or previously designed biomolecule based on the user's input of one or more components of a Part, a Device and/or a Circuit selected by the user from a database that comprises a plurality of components of existing biomolecules;
wherein the at least one data model is operable to manage development of the new designed or refactored biomolecule using one or more databases populated with information on the components of existing biomolecules; and
the computer program comprising instructions to perform an analysis of information on the components of the new designed biomolecule or refactored biomolecule; and
the computer program comprising instructions to provide the user an output comprising information that enables the user to determine in silico if the new designed biomolecule or refactored molecule is satisfactory or if one or more problems are associated with the new designed or refactored biomolecule.

16. The method of claim 15, further comprising development of an optimal method for designing or refactoring a biomolecule comprising:
implementing the BioCAD computer program to perform in silico a series of preliminary method steps for designing or refactoring a biomolecule by allowing a user to select a preliminary set of one or more parameters including one or more of the following: parts, devices, circuits that constitute the designed or refactored biomolecule;
implementing the BioCAD computer program to analyze the designed or refactored biomolecule comprising using the at least BioCAD tool and at least one data model and associated metadata for the analysis;
obtaining output generated by the computer program to identify any problem with the designed or refactored biomolecule;
implementing the data model to identify one or more steps of the preliminary method that caused the problems with the designed or refactored biomolecule;
using the computer program to refine individual steps identified to be the source of the problems of the preliminary method by allowing the user to reselect a secondary set of one or more parameters including one or more of the following: parts, devices, circuits that constitute the designed or refactored biomolecule; and
repeating this process of refining individual steps and reviewing the results in silico until an optimal designed or refactored molecule is obtained.

17. A system comprising:
a processor; and
a memory for storing instructions executable by the processor comprising the computer program of claim 1.
